(19) United States
(12) Patent Application Publication
(10) Pub. No.: US 2003/0032409 A1
(43) Pub. Date: Feb. 13, 2003

(54) Method and system for distributing content over a wireless communications system

(76) Inventors: Stewart Douglas Hutcheson, San Diego, CA (US); Craig A. Owensby, Washington, DC (US); Souheil Gallouzi, San Diego, CA (US); Mark Westling, Chevy Chase, MD (US)

Correspondence Address: REED SMITH LLP, 2500 ONE LIBERTY PLACE, 1650 MARKET STREET, PHILADELPHIA, PA, 19103, US

(21) Appl. No.: 10/100,603

(22) Filed: Mar. 18, 2002

Related U.S. Application Data
(60) Provisional application No. 60/276,056, filed on Mar. 16, 2001.

(51) Int. Cl. H04M 3/42

(52) U.S. Cl. 455/414; 455/403

(57) ABSTRACT

A method for providing informational content to a user of a communications device being wirelessly communicatively coupled to a communications network, the method including: identifying information associated with the user and indicative of user attributes; selecting a plurality of candidate messages using the identified information; pseudo-randomly selecting at least one of the plurality of candidate messages as selected content; and, delivering the selected content to the communications device using the wireless communications network.

### RELATED APPLICATIONS

This application claims priority of copending U.S. Patent application serial No. 60/276,056, entitled METHOD AND SYSTEM FOR CONTENT DISTRIBUTION OVER A WIRELESS COMMUNICATIONS SYSTEM, filed Mar. 16, 2001, the entire disclosure of which is hereby incorporated by reference herein.

### FIELD OF THE INVENTION

The present invention relates generally to methods and system for delivering content to users of a wireless communications network.

### BACKGROUND OF THE INVENTION

Wireless communications services is a fast growing segment of the telecommunications industry, worldwide. Although the Telecommunications Act of 1996 was intended to open the competitive environment in the United States, allowing new entrants into the local access loop, growth has been constrained by several factors. Some of these factors are endemic to any communications system (such as limited bandwidth and high capital costs). Other constraints are imposed by business models that have come to be generally accepted in the industry.

As a result of these constraints, the capacity of many wireless communications networks is managed primarily by cost. Specifically, network capacity is rationed to avoid over use of the network, by maintaining pricing levels that tend to limit usage. In addition, although enhanced informational content is desirable, the cost to the system operator of delivering such services along with the lack of standards for transmitting and delivering that information across different systems that employ divergent technologies have impaired the development of effective content distribution applications.

As a consequence of their focus on subsidizing the cost of wireless communications services of the type known prior to the present invention, prior known attempts to implement content delivery services have been directed primarily at providing advertising content, that is paid for by a third party.

For example, Iquity offers a variety of Internet and billing products, among which are services that Iquity markets under the “GRATISTEL” mark. Iquity has recently offered trial programs of sponsored telephony with individual customized content. Subscribers are given access to sponsored telephony, and in return they receive short messages, either during a call or before their call is connected. The messages are typically ten to fifteen seconds in length, and are played while the call is being connected. The messages can be individually customized and can be played regularly during the length of the call. The user receives a Personal Identification Number (PIN) code. Based on the PIN number and a questionnaire that the user completes at the beginning of the service, a unique customer profile is created, which is used to match content with the subscriber.

Several issued U.S. Patents disclose methods of providing advertising content. Welling, et al., U.S. Pat. No. 6,181,927BI, for Sponsored Call and Cell-Service, discloses a method for selecting and transmitting messages to users of a telecommunications' system. Welling compares call origination information to triggering criteria that has been stored in the network. Welling then selects a message to be delivered to the user based on one or more attributes of the subscriber's wireless communication access device, in response to the triggering criteria. Welling selects a message based on a hierarchy of first selecting a “sponsor group,” selecting a sponsor from among the sponsor group, and selecting a message from those available from that particular sponsor.

Bolduc, et al., U.S. Pat. No. 6,157,841, for Cellular Phone Network that Provides Location-based Information, discloses a wireless communications network. Bolduc's network has a database that contains location-based information indexed to the antennas of the wireless network. The server in Bolduc's system is adapted to present certain location-based information to the user, including the names of merchants local to the user. Bolduc is programmed to bridge an existing phone call to one of the merchants on the list.

Hidary, U.S. Pat. No. 5,852,775, for Cellular Telephone Advertising System, discloses a cellular telephone system having a central station for providing commercial messages to a mobile telephone user. A subscriber to Hidary's system receives a message of about 1 to 30 seconds when they initiate a call to a third party. The message could be of a general nature or could be selected from a group of messages based on information about the subscriber, such as age, sex, income, hobbies, profession, or other criteria. If the subscriber has indicated that they will accept commercial messages, a commercial message center provides commercial messages to a selector that provides the message to a subscriber.

Tajima, et al., U.S. Pat. No. 6,101,381, for Telecommunication System, Radio-Based Station Thereof, and Portable Telecommunication Terminal Thereof, discloses a telecommunication system in which a user receives a predetermined information message in return for a reduced communication fee. The messages sent by Tajima's network are stored in the memory of the portable telephone terminal. The user has the option to operate the information output switch which releases the message from memory and supplies the information to the portable wireless access device. Similarly, Tajima discloses that a reply to information that has been transmitted to the user may also be sent back to the radio-based station from the user's handheld device. Further, Tajima teaches a reduced communication fee associated with the information when the information is transmitted to the portable wireless device.

Kamel, U.S. Pat. No. 6,009,150, for Call Processing Method for Delivering Promotional Messages, discloses an interactive voice response and call-prompt system for delivering promotional messages. The user is permitted to select a desired number of promotional messages, which are played before the connection is established. Kamel's toll system outputs a number of promotional messages based on a desired time interval that the user selects. The user pays the toll for the call in the form of receiving a specified number of commercial messages. Kamel's messages, in turn, are selected from a hierarchy of messages.

Kamel, U.S. Pat. No. 5,937,037, for Communications System for Delivering Promotional Messages, discloses a telecommunications system for delivering promotional messages that includes a processor for comparing preset targeting criteria for each promotional message with profiled data for each subscriber. Kamel assigns individual message boxes for each user. Each subscriber has a unique message box or “queue” representing a one-to-one association of messages with the individual subscriber. In addition, Kamel's system has several more generalized queues, including usage-based, category, geographic, and general queues. Kamel works through the hierarchy of queues in assigning messages to a subscriber. When the subscriber registers with Kamel's system to receive messages, messages are provided in the order of the queues from individual to general.

Marino, et al., U.S. Pat. No. 4,850,007, for Telephone Toll Service with Advertising discloses a system for providing telephone toll service. Marino does not address a wireless communication system but, rather, a wireline system. The telephone subscriber selects the service to subsidize either directory assistance or telephone toll calls. Before the call is commenced, a recorded announcement is connected to the subscriber's line. The announcement typically includes at least one advertisement. The advertisements are selected from the database according to predetermined criteria. After the advertisement is completed, the toll call or directory assistance call is processed as usual at a reduced rate of charge, or with credit being given to the user's account. Although a number of prior disclosures suggest the use of advertising in a wireless communications network, most do so in the context of subsidizing the substantial expense of prior known wireless communication services. In general, the prior art fails to teach services that are tailored to the user's preferences as opposed to the advertiser's target characteristics; offer enhanced informational content; offer the user a progressively richer feed of informational content, both in terms of the quality of the content and richness of the formatting; have heuristic capabilities, and integrate the content delivered by offering progressive information content to deliver increasingly valuable and targeted information to the user.

Thus, there remains a substantial, long felt, and unmet need for content delivery services that: are tailored to the preferences of the user, as opposed to the marketing programs of advertisers or the desire of systems operators for higher revenues; have the ability to handle diverse types and formatting of content; offer sophisticated means for delivery and targeting content of interest to the user; match users to content based upon a user's preference; drive and encourage individuals to actively seek information through various channels, including traditional media; and, generally, provide value to the end user by providing timely, relevant, and personalized information. There remains a substantial need for heuristic matching capability.

### BRIEF SUMMARY OF THE INVENTION

A method for providing informational content to a user of a communications device being wirelessly communicatively coupled to a communications network, the method including: identifying information associated with the user and indicative of user attributes; selecting a plurality of candidate messages using the identified information; pseudo-randomly selecting at least one of the plurality of candidate messages as selected content; and, delivering the selected content to the communications device using the wireless communications network.

### BRIEF DESCRIPTION OF THE DRAWINGS

Understanding of the present invention will be facilitated by consideration of the following detailed description of a preferred embodiment of the present invention taken in conjunction with the accompanying drawings, in which like numerals refer to like parts and in which:

FIG. 1 is a schematic diagram showing the Media System and Network Architecture of a preferred embodiment of the present invention.

FIG. 2 is a schematic diagram showing the relationship of a cellular network of the type known prior to the present invention to the public switched telephone network;

FIG. 3 is a schematic diagram showing the interrelationship of the principal components of a cellular system adapted for voice communications of the type known prior to the present invention;

FIG. 4 is a schematic diagram showing the interrelationship of the various components of a cellular system adapted for both voice and data services, of the type known prior to the present invention;

FIG. 5 is a diagram depicting the logical interrelationship of various components of a preferred embodiment of the present invention.

FIG. 6 is a block diagrammatic representation of a media platform system 600 according to an aspect of the present invention;

FIG. 7 is a block diagrammatic representation of exemplary message filtering and campaign selection according to an aspect of the present invention;

FIG. 8 is a block diagrammatic illustration of an architecture suitable for use as the system 600 of FIG. 6 according to an aspect of the present invention;

FIG. 9 is a block diagrammatic representation of a network segmentation according to an aspect of the present invention;

FIG. 10 illustrates a flow diagram of a method for initial messaging and response during a call or action session;

FIG. 11 illustrates a flow diagram of a method for initial message response and a post action initiation session according to an aspect of the present invention;

FIG. 12 illustrates a flow diagram of a method according to an aspect of the present invention for audio-based response fulfillment;

FIG. 13 illustrates a flow diagram of a method for text message based response fulfillment according to an aspect of the present invention;

FIG. 14 illustrates a flow diagram of a browser based response fulfillment method according to an aspect of the present invention;

FIG. 15 illustrates a flow diagram of a method for image video based response fulfillment according to an aspect of the present invention; and,

FIG. 16 illustrates a process associated with content aggregation, provisioning and campaign creation.

### DETAILED DESCRIPTION OF THE PREFERRED EMBODIMENTS

As illustrated in the accompanying diagrams, the present invention generally is an improved wireless communications service, business method, operation method, and network and system for delivering the same. It is to be understood that the figures and descriptions of the present invention have been simplified to illustrate elements that are relevant for a clear understanding of the present invention, while eliminating, for purposes of clarity, many other elements found in content delivery and wireless communications systems, respectively. Those of ordinary skill in the art will recognize that other elements are desirable and/or required in order to implement the present invention. However, because such elements are well known in the art, and because they do not facilitate a better understanding of the present invention, a discussion of such elements is not provided herein.

According to an aspect of the present invention, a wireless communications system for providing content to a user may be provided. According to an aspect of the present invention, there may be utilized a wireless communications network including a wireless access device, content to be delivered to the wireless access device, and content selecting means for selecting the content based on user criteria.

According to an aspect of the present invention, a method for providing content to a user of a wireless communications network including providing content to the user of the wireless communications network based on user criteria may be employed.

According to an aspect of the present invention, a method for providing content to a user of a wireless communications network may include initiating a user call over the wireless communications network, determining whether the user is interested in receiving content, delivering content to the user based on user criteria, and completing the call may be employed.

According to an aspect of the present invention, a method for providing aggregated content to a user of a wireless communications network including receiving content from at least one content source, classifying the content into a plurality of categories, rating the content based on relevance factors and constraints, matching the classified and rated content with user criteria, selecting content to be provided to the user, and providing the matched content to the user may be employed.

According to an aspect of the present invention, enhanced information content may be provided to users of wireless communications services. According to an aspect of the present invention, multiple types of enhanced information content may be provided to users, in a variety of formats. According to an aspect of the present invention, users of wireless communications services may be provided multiple types of information content in a variety of formats that are adapted to the access device being used by the subscriber. According to an aspect of the present invention, targeted wireless audio, video, short message service (SMS), data, and electronic messages may be provided to a user of a wireless communications network.

According to an aspect of the present invention, targeted advertising messages may be provided to a user of a wireless communications network. According to an aspect of the present invention, the ability to follow up on targeted messages that are delivered to the user may be provided. According to an aspect of the present invention, a means to follow up on targeted messages that are delivered to them through a variety of media may be provided. According to an aspect of the present invention, a user means to follow up on targeted messages that are delivered to them through a variety or media either at the time of delivery of the message or at a later time may be provided. According to an aspect of the present invention, means to follow up on targeted messages that are delivered to them at the time the message is delivered or at a later time, through a series of progressively richer content interactions may be provided to a user.

According to an aspect of the present invention, targeted messages to a user of a wireless communication network based upon subscriber profile data may be provided. According to an aspect of the present invention, targeted messages may be provided to a user of a wireless communication network based upon the user's responses to targeted messages. According to an aspect of the present invention, targeted messages may be provided to a user of a wireless communication network based upon the pattern of location of the subscriber's unit. According to an aspect of the present invention, targeted messages may be provided to a user of a wireless communication network based upon the user's responses to inquiries from the system operator. According to an aspect of the present invention, content may be targeted to users based upon heuristic profiling that is adapted to identify content of interest to the user.

According to an aspect of the present invention, content may be provided in a variety of forms, including without limitation any one or more of weather reports; stock quotes; news reports; features; sports scores; standings; horoscopes; jokes; quotations; anecdotes; inspirational sayings; photographs; images; general information; reference information; advertising messages; games (single or multi-player); and other content of any other form or type. According to an aspect of the present invention, content may be provided to the user in any formatting adapted for the wireless communications network and/or access device employed by the user when accessing the invention, including, without limitation, any one or more of-advertisements; targeted advertisements; coupons; announcements; games; interactive messages; polls; e-commerce transactions; m-commerce transactions; Short Message Service (SMS) messages; email; ITPAP, HTTP, HTML, XML, HDML, WML, and/or WAP messages; Internet access; web site content; browser sessions; newsletters; books; magazines; photographs, drawings, diagrams, sketches, and other images; audio; music; video; and any other format that is adapted to be accessed through a wireless communication network, wireless access device, and/or other access devices.

According to an aspect of the present invention, voice mail, call waiting paging, data services, and/or Internet services may be provided. According to an aspect of the present invention, tailored information services adapted to the individual user may be provided. According to an aspect of the present invention, subscriber behavior may be modeled and services adapted to deliver content based on heuristic studies of the subscriber's preferences and behaviors.

According to an aspect of the present invention, location information may be provided. According to an aspect of the present invention, advertising may be provided to users or subscribers.

According to an aspect of the present invention, mobile commerce (m-commerce) may be facilitated. According to an aspect of the present invention, users' and subscribers' privacy may be safeguarded.

According to an aspect of the present invention, content may be provided to users of a wireless communications service that is based upon flat rate pricing. According to an aspect of the present invention, content may be provided through a wireless communications service, at a low flat rate monthly charge. According to an aspect of the present invention, content may be provided in the form of audio, images, video, and other formats adapted to the wireless access device being employed by a user.

According to an aspect of the present invention, informational content, including advertisements, as well as information about subscriber's preferences may be maintained. Audio content may be provided to users of the wireless communications network. When a user dials an outgoing call, to a number other than an X11 series number (such as 411 for directory assistance, and 911 for emergency services) and prior to the connection of the call, an audio message of about 10 to 12 seconds in length may be played for the user on their wireless access device. This message provide relevant and targeted information or promotions, based on the subscriber's preferences and behavioral profile, for example.

After hearing the initial 10-second message, the user may have an option to receive additional information, relating to the content of the first message or alternative additional information, in one or more of the following forms: a second, more extensive audio message, of up to about 30 seconds in length, after which the call may be completed; an additional text message that is delivered either while the second message is played or at a later time or location; a text message that is sent within 5-10 minutes of the user's request for the second message, comprising plain text and providing information that can trigger further actions such as making a purchase or requesting additional information by calling a provided number; an alert message that may be sent in some instances within 5-10 minutes of a customer request which, in addition to the plain text, included a phone number that could be automatically dialed and/or a browser session that could be automatically initiated to take the user to a web page containing additional information relating to the content of the audio message, including nearby point of sale information, promotions, and other related events; or an audio message may be repeated at the user's request during the audible session of that message.

According to an aspect of the present invention, offline action fulfillment methods for providing expanded content, such as, voice portal, voice-mail, e-mail, online portal, direct mail, and call back may be provided.

An Instant Messaging (IM) service may be provided to allow for the exchange of messages between wireless subscribers. Mobile originated and terminated messages may be delivered. Mobile initiated and wireline terminated, wireline initiated and mobile terminated, and wireline initiated and wireline terminated messages may also be delivered. As will be readily understood by those possessing an ordinary skill in the pertinent arts, such enhanced functionality may leverage functionality of a browser enabled wireless access device.

According to an aspect of the present invention, browser-capable wireless access device, such a browser-enabled handset, may be employed. This permits a user-initiated browser or data session that provides access to content in text form. Some content accessed through the browser may also be available in audio format. The browser functionality may provide the following services.

Headlines of local, national, sports and entertainment news may be provided. Current; impending; watches, warnings, and alerts related to the weather may be provided as well as daily, weekly, and long term reports and/or forecasts, for example. Movie related content may be provided, such as movie related information (including address, phone number, show times, ratings, reviews) by theater, movie name, new releases and coming releases. Yellow pages type content can be provided, such as by allowing a user to search for yellow pages entries by category or business name as well as standard directory listings including business name, locations, contact numbers, and directions, for example. Special offers, promotions, additional information, and e-coupons may be provided. A personal account may allow customers to manage their own profile and account information, including, without limitation, altering the user's preferences and areas of interest to further personalize and customize their service offering.

In contrast to prior known systems in which content is determined primarily by advertisers, according to an aspect of the present invention, users may express a preference for a mix of informational and advertising content. For example, a 60% mix of the messages heard by typical user may be informational in nature. Users may tend to focus on local events, news, and value-added information about events on their local area, major national headlines and weather, for example. Advertising content may comprise about 40% of messages heard by a typical user. It is believed that users will choose to receive certain commercial messages, even when other informational content is available, and even when it is not forced on them as it is in prior known systems. The advertising messages may include ads and/or promotions.

Moreover, the present invention provides a system that drives users to traditional information, media, commercial, and entertainment channels. For example, a user of the present invention may be stimulated to seek out further information by buying a newspaper, or may be encouraged to attend a movie at the local movie theatre based upon information received through the system of the present invention. The present invention can even help the user plan his or her activities for a weekend. This method of driving users to enhanced content can create new opportunities for increasing the system operator's revenue stream. Instead of receiving payment solely from advertisers, the operator of the present invention may receive payment from other channels, such as, but not limited to, newspapers, movie theatres, and restaurants.

In a preferred embodiment of the present invention, a variety of informational messages may be provided. A first, relatively short (e.g., 10-second) initial audio message, or text (SMS, for example), may be provided. This initial message may provide an incentive for the user to request additional information by announcing a special offer, discount, promotion or an exciting product or service. According to an aspect of the present invention, a method by which a user may take advantage of the offer may not be revealed until the additional informational message is provided. A second, relatively longer (e.g., 30-second) audio message may be played, or text messages presented for example, communicating additional details on the announced offer, or product or service, and provide an incentive to request an additional text message that may include contact numbers, address and/or directions.

A text message/UP-Alert message may be communicated to provide further details including contact numbers, address, directions, e-coupons, list of other offers and other related messages. It is believed that a key characteristics of an effective message service is that the messages are: simple, short, straightforward, to the point, relevant, personal, interesting, involving, entertaining, honest and worry-free. According to an aspect of the present invention, media operation means are provided to facilitate the delivery of the messages to the user in an appropriate format.

In a preferred embodiment of the present invention, advertiser campaigns, billing, and reporting are also managed. In a preferred embodiment, the present invention comprises a number of means that provide the intended functionality: Content Management Means; Content Hosting System; Content Selection Means; Content Distribution Means; Campaign Management Means; Merchandisers Management/Billing Means; Profiling System; Audio Production means; Media System Means; SMSC; WAP Gateway; IWF/PDSN.

It is believed that the content delivery method of the present invention is useful with any suitable wireless communications system, regardless of the need or lack of need for subsidizing cellular service. The present invention may be adapted to be used with systems of a type known prior to the present invention, as discussed in Hidary, or in conjunction with a Cricket' brand service offering, described in Applicant's copending applications, U.S. Provisional Application Nos. 60/241,830, 60/241,833, and 60/241,831, filed on Oct. 20, 2000, corresponding U.S. Utility application Ser. Nos. 09/772,065, 09/772,066, 09,772,067 which were filed on Jan. 30, 2001; and U.S. Provisional Application No. 60/252,468, filed Nov. 22, 2000, each of which are incorporated herein by reference. Although the subsidy effect is not needed in Assignee's Cricket brand service offering, in order to reduce the cost of the service offering to a level that is attractive to a larger number of potential users, the present invention provides enhanced functionality and value to all wireless communications users. The present invention may be used with either the Assignee of the present invention's business model, prior know models, or other wireless communications service models.

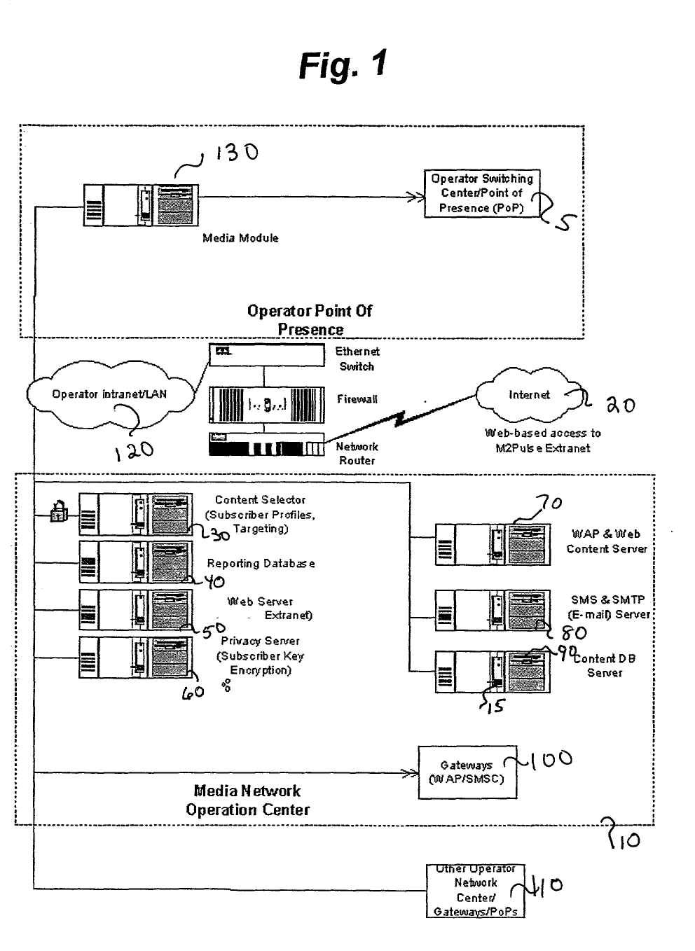

Referring now to the Figures, a preferred embodiment of the present invention is depicted in FIG. 1, which illustrates media architecture and components. The subsystems indicated in FIG. 1 may be co-located or distributed, depending on application, operation model, and needs. Some components may be aggregated or further subdivided, depending on system implementation requirements.

In certain preferred embodiments, in which the invention is deployed as part of a wireless communications network, the switching center 5 of the present invention may include the Mobile Switching Center (MSC) and associated network components of a typical wireless operation, including: base stations, Base Stations Controller (BSC), Inter-Working Function (IWF) or Packet Data Switching Network (PDSN), Billing Systems and Gateways. User devices may include, but are not limited to, mobile phones, Personal Digital Assistants (PDA's), notebooks, laptops, desktop computers, or any other form of mobile, portable or fixed devices or appliances, irrespective of form factor, that may interact or function in conjunction with a centralized network to achieve a specific function and capable of supporting content delivery in some form.

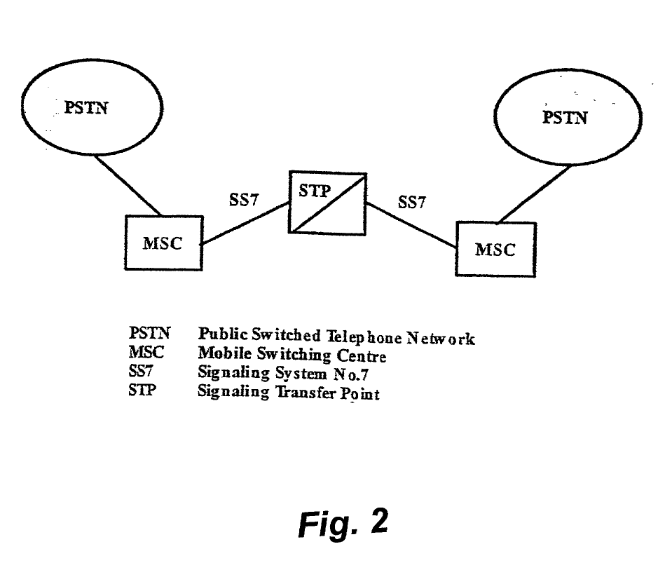

FIGS. 2, 3 and 4 illustrate the relationship between a cellular network infrastructure and the Public Switched Telephone Network (PSTN) in wireless communications systems of the type common in the cellular industry prior to the present invention. As is also well understood, IS-41 messages are routed via Signaling Transfer Points (STPs). The STPs handle network routing. In particular, they route to a Home Location Register (HLR) for a specific mobile phone handled by the STP. This has the advantage that, as the network expands and ranges of mobile phone numbers are assigned to different HLRs or new ranges come into service, only the routing tables in the STP need to be updated. Mobile Switching Centers (MSCs) do not need to maintain full routing tables to all other MSCs. FIG. 2 illustrates the functions and interfaces that support voice services. According to an aspect of the present invention, interface reference points may be defined in the IS-41 standard, to ensure correct interoperation of equipment. A typical cellular system prior to the present invention comprises an Authentication Center (AC). The AC manages the authentication information related to the Mobile Station (MS). The AC may, or may not be located within, and be indistinguishable from an Home Location Register (HLR). An AC may serve more than one HLR. The cellular system may further include a Base Station (BS). The BS describes the radio equipment at a single location used for serving one or more cells. The BS may include a Base Station Controller (BSC) and Base Station Transceiver systems.

The cellular system may further include an Equipment Identity Register (EIR). The EIR maintains user equipment identity information. The nature, purpose, and utilization continues to develop and the present inventors intend that all such uses to which these components may be put are considered part of the present invention. The EIR may, or may not, be located within, and be indistinguishable from an Mobile Switching Center (MSC).

The cellular system may include a Home Location Register (HLR). The HLR is the location register to which a user identity is assigned for record purposes such as subscriber information (e.g. ESN, MDN, Profile Information, Current Location, Authorization Period). The HLR may, or may not be located within, and be indistinguishable from an MSC. The HLR may serve more than one MSC. The HLR may be distributed over more than one physical entity.

The cellular system may include an Integrated Services Digital Network (ISDN): The ISDN is defined by the appropriate ANSI T1 Standards, which are incorporated herein by reference. The cellular system may include one or more Mobile Stations (MSs): The MS is the interface equipment used to terminate the radio path at the user side. It provides the capabilities to access network services by the user.

The cellular system may include a Mobile Switching Center (MSC). The MSC provides the interface for user traffic between the cellular network and other public switched networks, or other MSCs in the same or other cellular networks. The cellular system may include a Public Switched Telephone Network (PSTN). The PSTN is defined by the applicable ANSI TI Standards. The cellular system may include a Visitor Location Register (VLR): The VLR is the location register other than the BLR used by an MSC to retrieve information for handling of calls to or from a visiting subscriber. The VLR may, or may not be located within, and be indistinguishable from an MSC. The VLR may serve more than one MSC.

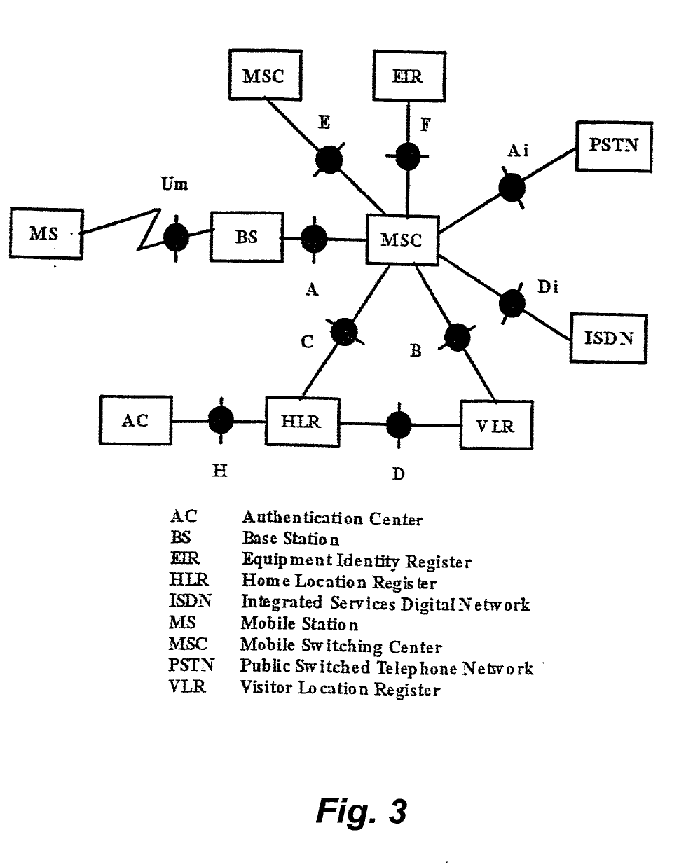

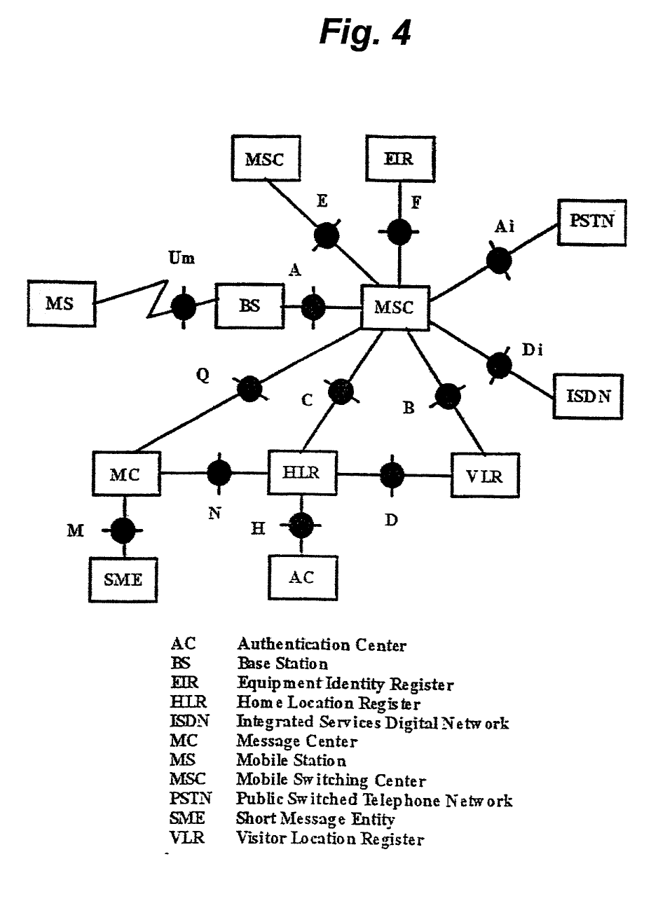

The main feature of the cellular network voice service when compared with Plain Old Telephone Service (POTS) is the geographical mobility of the phone. The equipment and interfaces depicted in FIGS. 2, 3, and 4 perform two main functions. First, they transmit and receive voice signals over the radio spectrum. This is primarily the function of the Base Station and Mobile Station, which occurs over the Um interface. Second, they track where each mobile phone is within the cellular network. This is called “mobility management” and is performed by the MSC, referencing and dynamically updating the BLR and VLR databases. As shown in FIGS. 3 and 4, this occurs over the C, D, B, and E interfaces.

The interfaces and standards associated with these two functions of RF transmission and mobility management are distinct to cellular voice services. The other interfaces are provided to offer mechanisms to connect the cellular network to the existing land line telephone network (PSTN or ISDN) or support authentication of users and equipment (AC and EIR), or special features such as the Short Message Service (SMS) (as shown in FIG. 4), that are not shown in the previous figures. These functions of network interconnection, security, and special services are not unique to the cellular network. Similar functions can be found in all land line telephone networks.

Standards suitable for a wireless communications systems for use with the present invention are identified in Table 1, each of which standards are incorporated herein by reference:

TABLE 1

| | Applicable | |
|---|---|---|
| | Standards | Comments |
| Interface | ITUASO | ANSI/TIA/EIA |
| A: BS to MSC | n/a | n/aIS-634 |
| interface | | |
| Ai: MSC to PSTN | X.25 | SS71S-93-A |
| interface | | |
| B: MSC to VLR | X.25 | SS71S-41.2, IS-41.3 |
| interface | | |
| C: MSC to HLR | X.25 | SS71S-41.2, IS-41.3 |
| interface. | | |
| D: VLR to HLR | X.25 | SS71S-41.2, IS-41.3 |
| interface | | |
| Di: MSC to ISDN | n/a | T1.611 IS-93-A |
| interface | | |
| E: MSC to MSC | X.25 | SS71S-41.2, IS-41.3, IS-41.4 |
| interface | | |
| F: MSC to EIR | not | not defined; |
| interface | defined | |
| H: HLR to AC | X.25 | SS71S-41.2, IS-41.3 |
| interface. | | |
| Q: | X.25 | SS71S-41.2, IS-41.3 |
| Um: BS to MS | n/a | n/aIS-54-B (TDMA and AMPS), IS-88 |
| interface, which | | (NAMPS), IS-95-A (CDMA), IS-95-B, |
| corresponds to the | | GSM, Edge, IS-136, (TDMA), GPRS, |
| air interface | | cdma2000, CDPD, PDC, THS, |
| | | WCDMA |

As used in herein, SS7 refers to the ANSI standards T1.111, T1.112 and T1.114. X.25 refers to ITU Recommendation X.25 and ISO 8878, ISO 8208 and ISO 7776.

Numerous consensus standards applicable to wireless communications networks have been promulgated by various bodies. The present invention is adapted to work with any of them. Further, one or more of the components of the wireless communications network, and in particular, one or more of the interfaces may be adapted to the present invention. It is intended that the invention cover such adaptations.

In addition to the above services, many wireless communications networks also feature Short Message Service (SMS). SMS includes the following additional elements. The SMS may include a Message Center (MC): The MC stores and forwards short messages. The MC may also provide supplementary services for Short Message Service. The SMS may include a Short Message Entity (SME): The SME composes and decomposes short messages. The SME may be implemented in many ways, such as an operator assisted service or interactive voice response service. An SME may, or may not be located within, and be indistinguishable from, an ULF, MC, VLR, MS, or MSC.

The interface reference points in FIG. 4, which support the Short Message Service, are: Interface M is the SME to MC interface; Interface N is the MC to HLR interface; and Interface Q is the MC to MSC interface.

FIG. 4 depicts a cellular network, of the type known prior to the present invention, which further comprises a Message Center (MC) and Short Message Entity (SUE), in addition to the infrastructure shown in FIG. 3.

As discussed in Assignee's co-pending applications identified above, the generally accepted business model for operating a wireless communications network has conventionally involved: primary business users, numerous additional voice features for which surcharges applied; relatively high Average Revenue Per User (ARPU); correspondingly high toll charges to the users to restrict usage of network capacity; widespread system geographic coverage, to secure additional revenues from roamers passing through the system and paying higher roaming surcharge rates; and primarily voice traffic. As a consequence of the high cost of use, the expansion of the base of cellular users has been constrained. Many innovations, therefore, have been targeted to adapting enhanced content services and in particular targeted advertising as a vehicle to subsidize wireless communications services and reduce their cost to the user.

In a preferred embodiment, the present invention includes means to enable the user to interact with the wireless communications network, the content provider, the content itself, or any of a variety of interactive applications employing content, including, without limitation: keypad interactions; voice activated responses; stylus responses such as a Palm” hand-held script, or any other appropriate script; personal profile enhancement questions; polls; games; e-commerce/m-commerce transactions; interactive applications with broadcast or other media; Short Message Service messages, and other forms of interaction.

In a preferred embodiment, the invention also includes methods, systems, and/or processes to enable and enhance the features of the present invention, namely: User Interface means, Content Aggregation means; Content Provisioning means; User Profile means; Content Campaign Management means; and Reporting means. The present invention may be adapted to be used with any type of wireless communication network and integrated with any other media that can deliver content. In a preferred embodiment, the present invention may be used in conjunction with the Cricket brand business method, operations method, network and system of the Assignee of the present invention, which are adapted to deliver wireless communications services at a higher overall network capacity, lower peak capacity, and higher overall network usage, relative to prior known methods, networks, and systems for delivering wireless communications services.

The present invention preferably is adapted to interrelate several levels of information content and formatting. The user may elect to receive or not to receive any of the content, in any of the formats, at any particular time, location, or circumstances in which the content is offered. The order of delivery of the content is not necessarily critical.

In a preferred embodiment, a user may be offered a brief message containing text, audio, video, graphic, or other content. Such messages may be targeted based on user's demographic information, preferences, behavior, responses and/or location. The user may choose to respond, or not. This may be followed by a response message, to which the user again may or may not respond. This in turn may be followed by additional content or information, delivered either on the wireless access device or through any other medium the user selects, such as the user's Personal Computer. These communications could include customized newsletters, email messages, links to web content, HTML or XML messages, or any other format adapted to the network and preferences of the user. These features enable the user to receive a progressively richer stream of information (for example, a short audio segment, to SMS, to customized newsletter), through a progressively richer stream of media (wireless handset, to PDA, to PC), about content in which they have expressed an interest. The user may elect to receive or not to receive any of the content, in any of the formats, at any particular time, location, or circumstances in which the content is offered. The order of delivery of the content is also not necessarily critical.

Reference will now be made in detail to a preferred embodiment of the improved method and system of the present invention, an example of which is illustrated in FIG. 1 as System 10. In general, the system 10 includes a content collector 30, reporting database 40, web server or extranet server 50, and privacy server 60. The system 10 may further include a WAP and WEB content server 70, SMS and SMTP e-mail server 80, and content server 90. These servers may be coupled to suitable gateways 100 such as a WAP or SMSC gateway. They may further be coupled to other operator network centers gateways or operator point of presence 110. The system 10 may further be coupled via an operator intranet or LAN 120 to a media module 130 which serves to interface the switching center 5 with the system 10. The operator intranet or LAN 120 may further serve to provide internet access to extranet 50, for example via suitable equipment such as an ethernet switch firewall and/or network router, for example. As embodied herein, the present invention comprises: Content means 200; and Content Selection means 300 for conveying information identifying content and delivering it to a user. In an alternative embodiment, the present invention comprises: Content means 200; and Content Selection means 300.

In a preferred embodiment of the present invention, the User Profile means 100 is a database comprising information about the users' preferences. The User Profile database is preferably compiled from a variety of sources. When the user subscribes to the service, the user may complete a questionnaire identifying certain preferences. The Profile may be enhanced with information drawn from internal, as well as external sources. Among the internal sources used to adapt the Profile are information about: the user's location; the user's interaction with the content delivery system; the user's purchasing patterns; the user's interaction behavior with the present invention; the user's location; and any other interactions between the user and the invention that are captured internally within the wireless communication network. Among the external sources used to enhance the Profile are: purchasing patterns; credit card information; bank card information; information provided by merchants, financial institutions, and others; demographic information; behavioral information; and a variety of other factors external to content delivery system of the present invention.

In a preferred embodiment of the present invention, this system 10 may be adapted to provide heuristic profiling capability (as a profiling means). A communication device may display personalized messages to the user of the device. The communication device may be a computer, television, wireless device, or the like, for example. The wireless device may be, for example, a cellular telephone, a programmable digital assistant, a short range wireless device, or other wireless device, such as a web-enabled wireless device. Use of the communication device may populate a database with data being indicative of use of the device, i.e., use data. This use data may be compared, by heuristic modeling, to general behavior data, in order to heuristically predict probable behaviors of the user in accordance with the comparison of the general behavior and the use data. A searcher may then produce messages relevant to the probable user behavior.

The use data may include, for example, profile information entered by a user. Additionally, use data may include data accumulated by device monitors, such as a wireless communications system base station, a time and location monitor a web-enabled device monitor, a wireless device monitor on a wireless device, a T1 or other hard-wired connection device monitor, a television channel monitor, a landline telephone monitor, an Internet monitor, or a purchasing monitor, such as a credit card machine. The general behavior data may include behaviors of multiple users monitored by the adaptive system, or other available information, such as that available over the internet.

In a preferred embodiment of the present invention, content means may include a database of information content. The content means may also include means for inputting content into the system and managing the content that is maintained by the system. The content may comprise: weather reports; stock quotes; news reports; features; sports scores; standings; horoscopes; jokes; quotations; anecdotes; inspirational sayings; advertisements; targeted advertisements; coupons; promotions; premium offers; announcements; interactive messages; questionnaires; polls; images; general information; reference information; games (single or multi-player); and other content of any other form or type.

In a preferred embodiment, the present invention further comprises content selection means 300, for matching content with a user's preferences to ensure that the content delivered to the user is of a type that is desired by the user. Content selection means 300 of the present invention may comprise a module that analyzes the user's preferences, along with the characteristics of the content to match appropriate content with the individual user. Content selection means 300 comprises various matching regimes, comprising algorithms adapted to provide enhanced heuristic functionality.

In a preferred embodiment, the present invention further comprises user interface means (not pictured). The User Interface means may comprise devices with which the user interacts with the invention to receive content. User interface means may comprise a wireless handset adapted to receive content. User interface means may further comprise browser-enabled handsets, as well as other mobile devices adapted to interact with the present invention, such as Personal Digital Assistants (PDAs), Wireless Application Protocol (WAP)—enabled handsets, and other devices adapted to receive content. User interface means may further comprise other modes of communication with the user, including Personal Computers (PCs), cable modems, television, and other interface devices.

It will be apparent to persons of ordinary skill in the arts that various modification and variations may be made to the content means and content selection means of the present invention. For example, the invention can be adapted as a content delivery service. Alternatively, the invention may be adapted as a system for delivering content to users of a wireless communications network. Alternatively, the invention may be adapted to one or more methods or processes used to deliver content to users of a wireless communications network. Thus it is intended that the present invention cover the variations and permutations of the invention, provided they come within the scope of the appended claims and their equivalents.

As embodied herein, the present invention may comprise a service offering for delivering content to a user of a wireless communications network. The user initiates the service by placing an outgoing call. Upon placing an outgoing call to a number other than a series X11 number (such as directory information—411, or emergency services—911), and prior to the connection of the call, a relatively short first audio message (about 10 seconds long) is played, providing relevant and targeted information or promotions to the user, based on the subscriber's User Profile. Following the initial first, short message, the user can then choose to receive additional related information in any one or more of the following, forms:

A relatively longer second audio message (typically up to about 30 seconds long) may be provided prior to, during, or after call completion. The user may still choose to receive an additional text message as described below during this extended message. The call is completed after the extended audio message is played.

If the service is offered and supported on a non-browser capable handset, a text message may be sent within 5-10 minutes of customer request, for example. This message consists of plain text providing additional information that can trigger further actions (for example, to make a purchase or request additional information by calling a provided number).

If the service is offered on a browser-capable handset, a UP-Alert message may be sent within 5-10 minutes of the customer request which, in addition to the plain text, may include a phone number that can be automatically dialed and/or a browser session that can automatically be initiated, taking the user to a related information page containing further information related to the content of the audio message. The information page may include directions to nearest point of sale information, promotions, and other related events.

An audio message may be repeated up to 2 times at the user's request during the audible session of that message, for example.

According to an aspect of the present invention, the system 10 may allow for the exchange of messages between users. The supported Instant Messages (IMs), may comprise: mobile-originated and mobile-terminated messages; non-mobile originated and mobile-terminated messages; mobile-originated and non-mobile terminated messages; and non-mobile originated and non-mobile terminated calls.

Browser services may be provided over a browser-capable handset. This facilitates a user-initiated browser or data session that provides access to content in text form (some of which is also available through the audio service). This service may include the following additional services. News: headlines of local, national, sports and entertainment news. Weather: daily and weekly local weather report/forecast; Movies: search for movie related information (including address, phone number, show times, movie ratings, etc.) by theater, movie name, new releases and coming releases. Yellow Pages: search for typical Yellow Pages entries by category or business name. Standard listings include the business name, locations, contact numbers and directions. Audio service advertisers on the system may be provided with enhanced listing features, comprising special offers, promotions, additional information and e-coupons. Personal Account: allows customers to manage their own profile and account information. This includes altering their explicit preferences and areas of interest to further personalize and customize their service.

In a preferred embodiment of the present invention, whether deployed in conjunction with a Cricket' brand wireless service offering of the Assignee of the present invention or a competitive service offering, the content delivery service may be billed separately or as part of the basic wireless service offering. Billing may be accomplished through a variety of billing mechanism, including Assignee's Cricket brand service offering (flat rate, unlimited use, pay-in-advance), or any of the variety of billing methods known prior to the present invention (monthly billing, prepaid minutes, ANI billing).

Advertisers may be charged on a variety of bases, comprising: Cost Per Impression (CPI); Cost Per Response (CPR); Cost Per Performance (CPP); Cost per lead; Cost per convergence; or premium charges for special features, such as top page listing; enhanced listings; an additional page on Yellow-Pages to include promotional information and/or e-coupons.

In a preferred embodiment of the present invention, the user interface means may comprise a wireless handset. To the extent that instant messaging and/or browser capabilities are desired, they may be supported on a browser-capable phone. Sales and distribution, customer support, and other features are rendered in conjunction with Assignee's Cricket brand service offering, or any of the variety of business models known prior to the present invention.

In a preferred embodiment, the present invention may comprise a series of enhancements that facilitate the management and/or offering of the services of the present invention. These enhancements may include a Content Management System; Content Hosting System; Content Selection and Distribution; Campaign Management System; Merchandisers Management/Billing System; Profiling System; Audio Production infrastructure; Media System Node; SMSC; WAP Gateway; and IWF/PDSN.

One of the primary features of a preferred embodiment of the present invention, is the use of an effective User Profile of the subscriber and/or user. In the present invention, when the user subscribes to the information content service of the present invention, preferably they would complete a questionnaire, expressing their likes and dislikes on a variety of topics. The information in the questionnaire may be maintained either by the network operator or by a third party cooperating with the network operator. The present invention preferably would continue to develop the User Profile through a variety of information sources. In a preferred embodiment, the user would complete an initial questionnaire and, possibly, follow-up questionnaires.

Data regarding the user and the user's purchasing habits and interests could be derived from a variety of other sources, including, without limitation: credit card purchases, responses to solicitations, coupon redemptions, other indications of interest in products or services, and a wide variety of third-party sources that may or may not be related to a wireless communications network.

In addition, the user's behavior in response to various information content supplied by the network may be monitored. The user's responses could then be used to improve the quality of the information by refining, not only the user's response to particular information stimuli, but also by comparing and contrasting the user's behavior to that of other users, in order to attempt to better refine the user's interests and provide content that is tailored to the user's desires. Further, information regarding the location from which the user is using their wireless access device, the time, and other conditions would also be used to improve and enhance the quality of the targeting of information to the user by the wireless communications network.

In a preferred embodiment of the present invention, a system operator of a system according to the invention may protect personally identifiable information about the user. In a preferred embodiment, the User's Profile information is encrypted and maintained in separate facilities so that system operators, advertisers, or other content providers who are employing the network operators' system to reach users would not have direct access to the personal identifiable information regarding the user. Alternately, personally identifiable information could be maintained relative to a wireless access device or group of wireless access devices (such as a user's telephone, Palm hand-held device, Blackberry brand e-mail device, and other wireless access devices).

In a preferred embodiment, the content delivery system of the present invention comprises a Multiple Media Personalization Platform (media platform or platform) platform, e.g. system 10, for supporting advanced targeting capabilities and providing personalized services across multiple media. The Platform allows users to set up and manage their profiles, allows the operator to offer a wide range of personalized services, and allows third parties to set up, manage and analyze their information and/or advertising campaigns for content delivery. The Platform further comprises reporting and billing functions. The Platform builds and maintains profiles enabling personalized content delivery to users, and continuous updating of Profiles based on responses and use of the personalized services.

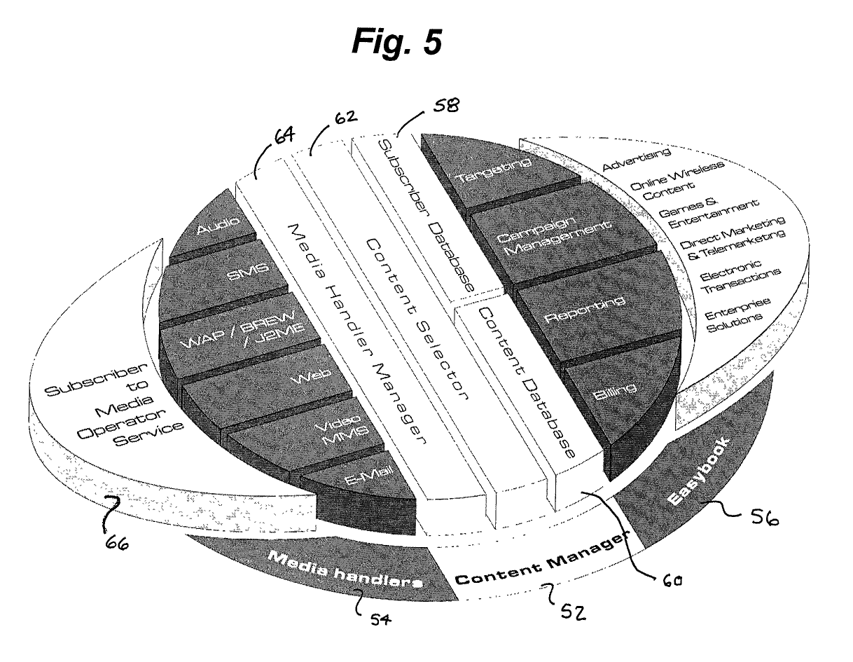

FIG. 5 depicts a logic diagram of an platform suitable for use with the present invention. In a preferred embodiment of the present invention, the Platform comprises three integrated subsystems: and platform 52, media handlers 54 and an Extranet 56. The Platform 52 may comprise: User Profile Database; Content Database; Content Selector 62; and Media Handler Manager 64. This subsystem manages functions that are independent of a particular medium. The Media Handlers 54 may comprise: Audio Handler; SMS Handler; E-Mail Handler; WAP Handler; and Web Handler. The handlers each provide a medium-specific interface to the end user 66.

The Extranet 56 may comprise: Targeting module; Campaign Management module; Reporting module; and Billing module. The extranet is a Web-based management interface to the System for advertisers, content providers, network operators, and service providers.

In a preferred embodiment, the present invention further comprises WAP and Web advertising and interactive responses. For example, in addition to ordinary audio “call backs,” response messages for an audio advertisement may be delivered as a text interactive SMS message or even as a queued WAP pop-up or Web ad.

In a preferred embodiment of the present invention, the Platform 52 serves three main functions: Storage and management of customer profile data, messages, and content. Matching and selecting the most appropriate content based on targeting criteria set by users and campaign owners, comprising profile attribute, type of medium, time and location. Matching further comprises as content-to-user (for “push” IAMs) or as user-to-content (for “pull” IAMS) delivery.

Delivering content/advertising messages on a real time basis, while having made selections for the type of IAM to be sent to the user whose profile is the best match. Also taken into account are time and location.

In a preferred embodiment of the present invention, the Platform interfaces with the user through multiple media touch-points: audio, SMS, E-mail, WAP, and Web. It provides a direct online interface to operators and third parties (e.g., advertisers). By knowing the user, the present invention places content based on time, location, and the User Profile. The personalized aspect of the service generates a positive perception by both the user and the advertiser/content provider. The user profile may be constantly enhanced based on predictive analysis of historical data based on user responses, interactions, and system usage. Further, the user can respond with the press of a key or voice-activated response to request more information. The system may send this information via the best medium suitable according to the campaign configuration associated with the content of interest and user device capabilities, preferences, location (if provided by Operator system), time and other criteria defined by the content application and user profile.

In a preferred embodiment, the present invention may further include User Profile. This Profile maintains the subscriber profile information, and may comprise various inputs. Data provided by the customer during the subscriber registration process, such as by filling in a preformatted questionnaire; Data based on actual responses by the user; Inferred data, based on responses; Data gathered in an outside transaction record database; Data gathered by the user's behavior on a related Internet portal; Data from external sources, including the system operator; or that is derived from data mining of external or internal sources that comprise relevant information; and Response behavior information, preferably when a sufficiently large existing group of profiles exists for comparison and such data is sufficient for statistically valid projections.

The Platform 52 may be adapted to use response data to update and enrich Profiles by inferring information about the user 66. For example, a user may respond to an SMS ad for river rafting. This response may be used to enrich the respective customer profile with an indication that the user is interested in active outdoor activities, which is used for more precise targeting for other content relating to similar activities. When a female user responds several times to baby messages, the profile could change a “no children” attribute provided during registration to a “very young children” attribute. This inference process may be applied to virtually any attribute within the user's profile. Each response may be considered an indicator of the content's attractiveness to individuals with particular attributes. Each response therefore comprises additional inferred information about the user.

In a preferred embodiment, the system of the present invention may further comprises Content Database means, e.g. database 60. The Content means maintains content as well as requirements for delivering content set by the systems operator, and advertiser, or the content provider; The type of initial Interactive Message (audio, SMS, E-mail, WAP, or Web); The type of response message as part of the campaign (an optional first and an optional second) and response delivery setting (automatic, on request, and multiple); Targeting requirements of campaign based on user profile (excluded or required attributes), time of day, day of the week, and location; Language format(s); If applicable, budget for the campaign over time of campaign; and Beginning and end of campaign.

For interactive messaging, the user may create multi-level conversations with the customer, asking questions and seeking responses. These responses may comprise further responses, in order to create a hierarchical content accessing option. As embodied herein, the present invention further comprises an extranet interface, described below, that allows operator partners to script these conversations online. Scripts can be entered and altered for activation in near real time.

In a preferred embodiment, the present invention further comprises Content Selector means e.g., content selector 62. Content Selector means employs pattern recognition techniques to select appropriate content. In a preferred embodiment of the present invention, Content Selector means comprises means for choosing up to four items out of a possible 1,000 within 100 milliseconds, for example.

Targeting may be based upon the geographic location from which a user makes a call. Data means may also be provided to determine the subject matter of content a user is navigating, or the city for which a user is requesting information. For example, if an advertisement is sent to the user about Nike shoes and the consumer responds, the system could receive the mobile location from the operator, identify the Nike retailer closest to the user at that time, and recommend a purchase location.

Content Selector means further includes means for choosing the medium that will be used to reach the user for an IAM or a response message. Response capabilities may be dependent on the services a provider wishes to allow, the availability of medium-specific information for users (e.g., E-mail addresses), and the formulation of the content delivery campaign.

In a preferred embodiment, the present invention further comprises a Media Handler Manager 64 for delivering content through an appropriate media. The Media Handler Manager may be adapted to interact with other platform subsystems to deliver responses through predefined media (this response can be generated automatically or at the user's request), by sending response behavior data which can be processed to enrich and update the customer profiles, and by creating records for campaign reporting and billing purposes. As embodied herein, the present invention preferably further comprises Media Handlers 54 for delivering content across media. The present invention preferably supports a variety of media.

Audio messages may be provided in initial 10 to 15 second initial audio IAM messages; and informational response message of up to about 30 seconds. The user may typically be prompted to respond with a key press during a longer response message for a direct connection to a predefined phone number, such as a customer service call center or a sales outlet. Availability of the direct connect feature can be set based on hours of operation of the call center, for example.

SMS messages, or a form of text paging via wireless phones, can be pushed to users or sent to users as a response message. “Follow-up” messages may be sent as a reminder, automatically following a 30 second audio response message. Response messages may also be generated at a user's request during a 10 second initial message or 30 second call back. These messages may provide e-coupons, telephone numbers, retail location addresses, for example. SMS messages may also be pushed as a text-based advertising message or promotional offers. In addition, NVP interactive SMS handler means tracks messages through unique B-number tags assigned to each transmission. The handler may allow up to three or more concurrent conversations per user, each conversation being enabled to involve up to five or more interactions, for example. Interactions are preferably scripted through the extranet, and may be based on multiple-choice responses to which the user can respond. Responses may require that the user reply to a message, entering an option chosen. The handler will then read the response and deliver the appropriate response message for the conversation. This capability enables the request of optional content offerings, and research projects that involve “tree” structure questionnaires, as well as, responsive advertising.

E-mail messages may be pushed to users or sent to users as a response message. “Follow-up” messages may be sent as a reminder following a 30 second audio response message, or generated at a user's request during a 10 second initial message or 30 second call back. These messages may provide e-coupons, telephone numbers, retail location addresses, concert sites, book-signing locations, for example. E-mail may also be used to push text-based advertising messages or promotional offers. E-mail messages may be either plain-text messages or graphic-enriched HTML messages. Either type may contain hyperlinks to appropriate web sites for example.

A Wireless Application Protocol (WAP) handler means allows use of the WAP “wireless web” medium as an integrated part of content delivery campaigns and personalized content delivery services. WAP messages containing menu options can be delivered directly to the user, eliminating the cumbersome process of manually typing a WAP Uniform Resource Locator (URL), for example. In a preferred embodiment, the present invention may support personalization of a WAP home page by inserting or adding menu URLs; and inserting one or more banners or pop-ups before or during WAP sessions to support integration of audio content. An IAM may contain a link with Wireless Telephony Application Interface (WTAI) instructions to dial a number that plays an audio recording over the voice channel. The present invention preferably supports various IAM styles: such as temporary and Pop-up

Temporary (such as eight-seconds in temporal duration) IAMs that flash on the mobile device display before the actual content page is shown may be provided. The user can respond to a flash IAM by clicking on the message, which will then take the user to a detailed page. The message can either be an image (WBMP) or text. Such IAMs may be “interstitial” in nature, occurring between pages. Online banners may be provided, as images for example, with a content page being displayed. They may contain a WAP URL that is visited when the user activates, or clicks on, the banner for example. Text inclusions may also be provided similarly to banners. Pop-ups may also be provided similarly to flash messages, except for that pop-ups may stay on the screen until the user acts upon them, i.e., by clicking the appropriate link. Such messages may also be “interstitial” in nature, occurring between pages.

A hyperlinked URL may be delivered directly to the mobile device, e.g., phone, screen of the user (sent by SMS) and can be used to access a WAP site directly where mobile and infrastructure allow.

The present invention preferably employs the World Wide Web (Web or WWW) as an integral part of audio advertising campaigns and personalized content delivery services. Through Web advertising messages, links and content: suggestions can be delivered; personalization of a user's portal home page may be personalized; and all standard Internet advertising formats may be supported, including: pop-ups, banners, dynamic IAMs and scrolling text, for example. When a user visits a Web page, a small window may pop up, as is conventionally understood, containing a targeted message. The pop-up may be in the form of an HTML page, which can contain images, text, forms, and flash movies, for example. An image (such as a GIF or JPEG) banner linked to a URL that is visited when the user clicks on the banner may be presented. Unlike other messages that stay at fixed locations, moving IAMs may change their position on the page, increasing the likelihood of a meaningful impression (each of these messages being in standard HTML format, for example).

An informational text message that scrolls across the page, from right to left for example, may also be presented. Resident messages that stay at the top or bottom of the page even if the user scrolls up or down may also be provided using standard HTML formatting.

In a preferred embodiment, the extranet may further serve for targeting, campaign management, reporting, and billing services. In a preferred embodiment it may provide: (1) subscriber statistics: Number of registered users; Number of new registrations; Number of active users; Number of calls and time used; Number of IAMs inserted and played to completion; Number of responses; and Demographics of all registered users. (2) Advertising billing: This capability provides information on billed advertising revenue. (3) Targeting: Advertisers can select their target segment for their campaign using all the aggregated data available from the E-Personalities and can define time- and location-based target requirements; (4) Campaign Management: Advertisers can monitor the available and spent budget and change target settings for their campaigns; (5) Response Analysis: Advertisers can analyze responses to their campaigns and view demographic information of users who responded. And, (6) Billing: Advertisers can view billing details online.

Media used for delivery may include: audio, SMS, WAP, E-mail, and Web. Equipment may be installed at the operator's location or any other location. Monitoring may be provided 24/7 basis, directly or through a remote monitoring facility. The Media Handlers of the present invention preferably include audio handlers for delivering voice and content through a provider's network. The preferred configuration may be dependent on the network interface employed.

In a preferred embodiment, the present invention further may include Privacy Server for translating an unencrypted subscriber identification key (which can potentially be matched with a subscriber's name or other personally identifying information) to an encrypted identification key, under which all User Profile information is stored. This “black box” process may erect an electronic wall between the Profile and attribute targeting data and an individual. Encryption keys are preferably used for all translations. As embodied herein, the Privacy Server of the present invention preferably comprises: Hardware: Dell PowerEdge 1300, Intel Pentium HI processor; and Software: Subscriber privacy server encryption software.

In a preferred embodiment of the present invention, the subscriber's phone number (MSISDN) may be specified as the unique subscriber identifier. This function, however, may be any sort of user name or access code.

As embodied herein, the Extranet of the present invention preferably further include a: Reporting Database; Web Server; targeting module; campaign management module; reporting module; and billing module.

In a preferred embodiment of the present invention, the Web Server includes: an extranet user interface to the database systems. It is preferably accessed using a standard Web browser over the Internet.

Access to the Web Server is protected with 40-bit Secure Sockets Layer (SSL) encryption. Authorized users of the Extranet are assigned user names and passwords and a level of access to features and accounts to which each user is allowed access. In a preferred embodiment of the present invention precautions are taken to ensure that advertisers cannot view competitors' campaigns.

The Web Server preferably supports up to 1,000 concurrent users, for example. If desired, additional servers can be specified for added capacity and availability, providing a scalable application. Sizing of the system depends on the method of integration, as well as the number of subscribers to be supported. If required, the Web Server can also function as part of the provisioning process and allow users access to their User Profiles. The server may be configured to: provide promotional information about the service; allow users to register with the service and complete profile questionnaires; and allow existing users to view and/or modify their Profiles.

In a preferred embodiment of the present invention, tile Web Server comprises: Hardware: Dell Power Edge 2450, Intel Pentium III processor; and Software: Windows NT 4.0 Service Pack 5 or Windows 2000, Microsoft IIS, Cold Fusion Enterprise.

In a preferred embodiment, the present invention comprises multiple types and forms of User Interface models. When a call is initialized, the form of the IM is defined in the Media System associated content campaign. The IM is selected by the media system, based on campaign criteria and User Profile. The IM is delivered to the user. The user may then request additional related information or actions. For example, the user may request, prior to call connection, connection to a telemarketing center, voice portal, or IVR, depending on the requirements of the campaign, using the device keypad, voice activation commands, or a stylus. The action is completed, once all applicable actions and messages are delivered.

The user may also initiate certain actions to save or post certain messages onto the same or alternative media. For example, an audio message may be saved to the user's personal voice mail or portal. Depending on content campaign definition and User Profile, a post action (or offline) content fulfillment step may apply, in which case the user may receive additional information via one or more additional media. For example, an information message delivery may trigger the delivery of a personal email, providing more details and links to the story or event of interest.

The campaign associated with the IM and related messages/actions defines the allowable path(s) in the interface model.

Alternatively, triggered action may be completed immediately after delivery of the selected IM. In this scenario, completion of the user's triggering action is not delayed beyond the delivery of the IM. Additional information or further actions may be performed independently of the triggered action. This assumes that either both actions may be performed simultaneously, or in sequence, depending on the application, selected medium, and device. Sequencing is defined in the campaign associated with the IM and related messages/actions.

The user profile may allow the user to bypass an IM delivery or interruption, following a triggering action, based on constraints definable in such profile. For example, a user may subscribe to a IM fast forward feature” that may be subject to certain limitations, such as, number of uses in a given time period, or that applies only to certain types of messages or triggering actions.

An IM may be triggered based on the media routing rules or triggers. Such triggers are provisioned in the Operator Switching System or Media System, for proper routing and handling. In a preferred embodiment, such rules or triggers in the context of a mobile network when applied to call origination, may include, without limitation: call origination, excepting X11 calls (such as, 411 or 911 calls); & Local call origination with the exception of X11 calls; Call origination starting with a specified dialing sequence or prefix (for example, long distance calls); All call origination with the exception of certain numbers-specified, based on dialing prefixes or format; Call origination made during certain time periods or days; Call origination with minimum time intervals apart; Call origination not prefixed by a given dialing sequence.

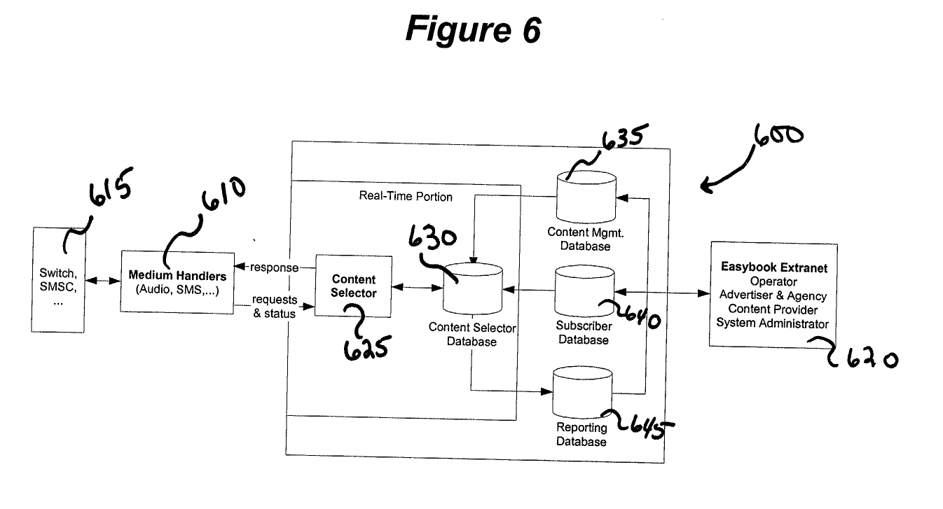

Referring now to FIG. 6, there is shown a block diagrammatic representation of a media platform system 600 according to an aspect of the present invention. Generally, the system 600 includes a content selection platform 605 communicatively coupled to medium handlers 610, in turn being communicatively coupled to a switch 610 for example. The system 600 is further communicatively coupled to extranet 620.

According to an aspect of the present invention, the system 600 includes content selector 625 for selecting content and managing medium handlers 610 and being communicatively coupled to a content selector database 630. The database 630 may further be communicatively coupled to a content management database 635, subscriber database 640 and reporting database 645. The databases 635, 640, 645 may further be communicatively coupled to extranet 620.

According to an aspect of the present invention, the content selector 625 determines which messages to deliver to subscribers. Unlike many other telephony-based advertising systems, the content selector 625 may operate substantially in real time: that is messages may be selected when needed, and not computed ahead of time and placed in delivery queues. This means that the content selector 625 can respond substantially immediately to changes in subscriber location, profile, or message targeting.

Content selection by the content selector 625 includes three major components. The first component considered is the subscriber's service plan. The service plan dictates the call flow or service capabilities, which may be set by the operator when the system is customized for a particular service. Service plan options may include: number of messages to be delivered at a time; maximum number of messages per day; minimum amount of time between message deliveries; relative percentage of each message type (such as advertisement, content, or tutorial) per day; amount of subsidy, if any, given to the subscriber for each delivered ad; and whether a Call Deatiled Record (CDR) should be generated to reflect a subsidy (or a charge).

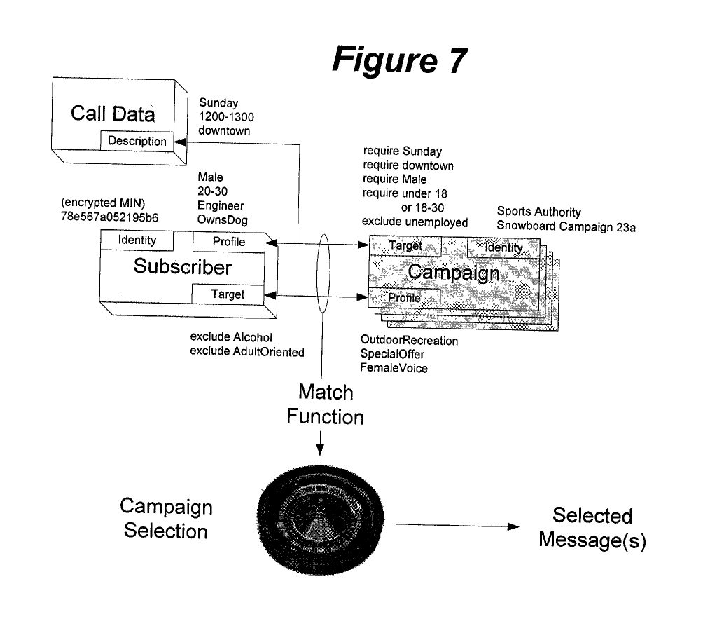

After the service plan is considered, the content selector 625 performs message filtering and campaign selection. Referring now also to FIG. 7, there is a shown a block diagrammatic representation of exemplary message filtering and campaign selection according to an aspect of the present invention. Message filtering produces a list of messages that the subscriber is eligible to receive by matching attributes of the subscriber and the call itself with campaign targeting rules, such as: exclude subscribers who have certain attributes (i.e., unemployed); require certain every attribute (i.e., downtown, Sunday, male); require that subscribers have any of a list of attributes (i.e., under 18 or 18-30); similarly, advertisements and content can have attributes that are targeted by subscribers (i.e., exclude all alcohol or adult-oriented messages). Filtering may also include the subscriber's history: such that a message may be specified as playing a limited amount of times in a certain time period (i.e., once per day) for example.

Referring still to FIGS. 6 and 7, the third component may be semi-random, or pseudo-random, selection. After targeted message filtering, the content selector 625 has a list of candidate messages, all of which are eligible for delivery. There may be more messages available than needed, so the appropriate number of messages may be selected from the candidate list based on priority. A priority can be assigned manually or computed automatically to satisfy the budget and time constraints on an advertising campaign. The highest priority messages may not be chosen automatically for example, but rather factor into a semi-random selection weighted by priority. For example, if two messages are eligible to be played and one has a priority twice that of the other, then the one with the higher priority may be twice as likely to be selected. The effect is like having a weighted roulette wheel where messages cover the number of slots equal to their priority. This allows the content selector 625 to provide variety to the subscriber and still satisfy the goal of delivering a certain number or certain percentage of message over a period of time.

Referring still to FIG. 6, content selector database 630 may contain data needed by the content selector 625 for operation. These data may be created and maintained in the Content Management Database 635 and the Subscriber Database 640 but migrated in real-time to the Content Selector Database 630 in operation of the content selector 625, for example. This ensures that the Content Selector Database 625 can serve the Content Selector 625 without interference from other applications.

The Content Selector Database 630 may also receive transaction results from the Content Se-lector 625, including messages selected for delivery to each subscriber, the status of each delivery, and the subscriber's response (if any). These results may be migrated in real-time to the Reporting Database 645. Periodically, old results that have already been migrated to the Reporting Database 645 may be deleted to conserve space and preserve speed, for example.

Referring still to FIG. 6, content management database 635 may contains campaign requirements defined by an advertiser, agency, or content provider, for example. Basic information contained in database 635 may include: an initial message, including the medium on which it will be delivered (for text media such as SMS, messages may be stored directly in the Content Management Database 635; for audio, sound files are stored at the VRU and only the file names stored in the content management database, for example); a description of the advertisement or content type (i.e., news, weather, traffic, dining, automotive); an indication of whether the subscriber receives this message via explicit pull (by going through a voice portal or by dialing a #-code associated with the advertisement or content type), implicit pull (for services where messages are delivered automatically in response to a subscriber action, i.e., making a phone call), or push (for example, an SMS sent at a prearranged time); targeting rules for the initial message (i.e., descriptions of which subscribers are eligible to receive the message and which are excluded from receiving the message); response messages, with delivery criteria (i.e., the key press that links a pre-ceding message to this response message); a start date/time and end date/time of the campaign; and, a budget (if applicable) to be expended over the duration of the campaign.

In addition, the following advanced targeting capabilities may also be represented by suitable data in the database 635: management of the frequency that a message can be delivered to a specific user (i.e., the maximum number of times that a given message can be delivered in a given time period); creation of “storybook” campaigns, where a series of campaigns are organized sequentially to tell a “story”; and prevention of competitive ads being delivered together.

Referring still to FIG. 6, subscriber database 640 may contain profile and other information about subscribers registered for services. Database 640 may include: identifying information, such as the mobile number passed to the VRU by the switch (MSISDN or MIN), or email address (information that can personally identify a subscriber may be encrypted using suitable techniques for security purposes); service plan(s), which may include limits on the number of messages the subscriber should receive per day, amount of time between messages, and other parameters related to call flow and enabled services; demographic data, obtained either through a questionnaire or through external databases, for example; preferences, such as kinds of content that the subscriber wishes to receive and other personal interests; historical information, including what messages the subscriber has heard be-fore and how the subscriber responded (if at all) to the messages; external data, such as information from an operator's database or segmentation data generated by data mining processes; subscribers can be provisioned either through the extranet 620 or through bulk-load processes. According to an aspect of the present invention, subscriber data may be maintained through the extranet 620 either by service representatives or through a conventional web interface, for example.

Referring still to FIG. 6, reporting database 645 may contain data for system 600 reporting and analysis. It may be structured using data warehouse methodologies as a dimensional database, with fact tables, aggregate tables and conformed dimensions. Reports may use the aggregate tables for queries, for example.

Referring still to FIG. 6, messages are delivered to subscribers through medium handlers 610. A medium handler may take the form of a system component that interacts with a subscriber over a particular medium, such as audio, SMS, email, web, or WAP. According to an aspect of the present invention, a medium handler may: deliver messages appropriate to the medium; detect subscriber responses appropriate to the medium; and, accept delivery requests from the Content Selector 625 and send status and subscriber responses back to the Content Selector 625.

Audio messages may be provided in different content formats, such as: 10 or 15 second initial audio message; and up to 30 seconds for an informational response message. The audio medium handler may detects key presses (DTMF) indicating subscriber responses. Also available is direct connection capability, automatically or by request. In a typical configuration, the subscriber may be prompted to respond with a key press during a response message for a direct connection to a predefined phone number such as a customer service call center or a sales outlet. If necessary, availability of the direct connect feature can be set based on hours of operation of a corresponding call center, for example.

An audio medium handler processes outbound calls routed to it by the switch 615. It may either (a) hand the call back to the switch after delivering messages or (b) handle the call throughout its entire duration (a process known as tromboning, due to the fact that the connection goes in and out of the VRU from the switch). It may also handle “short code” calls associated with retrieving specific types of content or advertising. The switch 615 can route short-code calls to the VRU, which would recognize the code, request a specific type of content or advertising from the Content Selector 625, and terminate the call after the message is delivered. Finally, the audio medium handler can be used to implement a voice portal. The voice portal is an application that lets subscribers select content and manage their profiles by navigating menus using DTMF and voice recognition.

In a preferred embodiment of the present invention a Voice Response Unit (VRU) or audio interface, may include: Hardware: Industrial PC, Intel Pentium III processor, Dialogic voice processing boards (D480SC2T1 for TI, handback; D240SC2T1 for TI, tromboning; D600SC2E1 for EI, handback; D300SC2E1 for EI, tromboning), SS7 SIU or interface board (if SS7 is used). Software: Windows NT 4.0 Service Pack 5 or Windows 2000; Parity VOS software; and the Assignee's proprietary audio handler application. WAP, Web, SMS and E-mail Media Handlers: These media handlers preferably provide the interface between the subscriber (via the provider's network or the Internet) and the NFP Platform.

According to an aspect of the present invention, a Pentium III 733 mhz processor, 512 mb RAM, four (4) 9.1gb SCSI-3 10k hard drives in an internal bay, Dialogic voice processing boards (D480SC2T1 for T1, handback; D240SC2T1 for T1, tromboning; D600SC2E1 for E1, handback; D300SC2E1 for E1, tromboning), SS7 SIU or interface board (if SS7 is used) and a suitable operating system like Microsoft Windows 2000, and Parity VOS software can be used to provide audio handling capabilities (for example through the VRU).

SMS messages can be pushed or sent to subscribers as a response message, including: “Follow-up” messages as a reminder, which messages may be automatic following a 30 second audio response message; response messages generated at a user's request during a 10 second initial message or 30 second call back. These could provide e-coupons, telephone numbers, and retail location addresses, for example; and, pushed as a text-based advertising message or promotional offer. SMS messages may be limited to a given number of characters, such as 160 alphanumeric characters under the GSM standard (other standards having different requirements).

The Media Platform SMS handler may track messages through unique B-number tags assigned to each transmission. The handler may allow up to three concurrent conversations per user, and each conversation allowing up to five interactions, for example. Advertisers or content providers may script interactions through the extranet 620 by specifying selections to which the subscriber can respond, for example. Responses may require that the subscriber reply to a message and enter the option chosen. The SMS handler may then read the response and deliver the appropriate response message for the conversation.

E-mail messages can be pushed to users or can be sent to users as a response message. They may be either plain text or graphics-enriched (such as HTML, for example). Either type may contain hyperlinks to an appropriate web site as well.

The Web can be used as an integrated part of audio advertising campaigns and personalized content delivery services, including: personalization of a subscriber's portal home page; and, conventional Internet advertising formats, such as: one or more Pop-Ups (When a subscriber visits a Web page, a small window may pop-up containing a targeted message. The pop-up may take the form of an HTML page, which can contain images, text, forms, and/or a flash movie, for example.); one or more banners (An image (GIF or JPEG) banner linked to a URL that is visited when the subscriber clicks on the banner.); dynamic/moving elements (Unlike other messages that stay at fixed locations, moving messages can change their position on the page. Each of these messages may be in a standard HTML format.); scrolling (This is an informational text message that scrolls across the page from right to left, for example.); and resident (one or more messages that stay at the top or bottom of the page even if the subscriber scrolls up or down. This message may also be in a standard HTML format.)

A WAP handler allows use of this medium as an integrated part of advertising campaigns and personalized content delivery services. The following are examples of content presentation that may be available: personalization of a WAP home page by inserting or adding menu URLs; insertion of banner or pop-up initial messages before or during WAP sessions. These can support integration of audio content, that is such a message may contain a link with WTAI (Wireless Telephony Application Interface) instructions to dial a number that plays an audio recording over the voice channel.

The following may be supported message styles. Flash: Eight-second initial messages that flash on the mobile device display before the actual content page is shown. The user can respond to a flash initial message by clicking on the message, which will then take the user to a detailed page. The message can either be an image (WBMP) or text. Such initial messages are “interstitial,” occurring between pages. Banner: Banners (as images) are online with the content page being displayed. They may contain a WAP URL that is visited when the user clicks on the banner. Text: Similar to banners, except for the fact that they are text-based. Pop-Up: Similar to flash messages, except for the fact that pop-ups stay on the screen until the user acts upon them, i.e. by clicking the appropriate link. Such messages are interstitial. Delivery of a hyperlinked URL directly to the phone screen of the user (sent by SMS) that can be used to access a WAP site directly is possible where phones and infrastructure allow, for example.

For WAP, Web, SMS and e-mail handlers, the following may be used: multiple (such as 2) Pentium III 733 mhz processors, 512 mb RAM, a Compaq 5304 raid controller, 4×18.2 gb SCSI-3 15k hard drives in an internal bay, 2×9.1gb SCSI-3 15k hard drives in internal cage suitable operating system such as Microsoft Windows 2000 and suitable software to support integration with an existing WAP gateway, web site, SMSC, or email servers.

Referring still to FIG. 6, system 600 may be made accessible though the extranet 620, which according to an aspect of the present invention may provide reports, content provisioning, subscriber provisioning, and general system control functions to advertisers, agencies, content providers, operators, and system administrators.

Extranet 620 may include dynamically generated web pages forming a website tailored to individual or collective users. Users may have a login tied to their business type (advertiser or customer care, for example). Each business type may have a different view of the system and access to different groups of tools. Within each business type, individual users have different access privileges, which are set by administrators. The extranet 620 interface may be customized to a client's specification (colors, logos, user prompts, confirmation messages, screen layout, features, and links to other websites). Further, extranet 620 may support multiple languages and multiple currencies. Each login can be associated with a particular language and a particular currency, and currency conversion is performed automatically. Asian (multi-byte) languages may be supported, for example.

Utilizing extranet 620, advertisers and content providers can monitor, update, and modify their campaigns through the Campaign Targeting, Allocate Funds, Manage the Creative and Telemarketer Information tools and analyze detailed statistics through the Campaign Performance features, for example. Campaign Targeting: this feature includes an overview of the campaign's current targeting strategy and allows an advertiser to review and modify/update the targeting criteria as needed, including: general information about the ad package (i.e., ad files and telemarketer in-formation); demographics (i.e., gender, age, income range); location (i.e., specific areas in the city that the advertiser would like to tar-get customers) and time (i.e., the times the advertiser would like to target customers). Advertisers can choose to include or exclude certain characteristics to create their ideal target customer for a particular campaign; the more specifically a campaign is targeted, the more directed the advertising becomes. Allocate Funds: this feature allows advertisers to distribute available funds across current, active campaigns to influence the number of messages delivered within a certain timeframe. Manage the creative: this feature allows content providers and advertisers to specify and manage their messages. Conventional wizard help features (Wizards) for creating customized ad campaigns may be provided. A Creative Management Wizard may be provided as a session-based tool that allows advertisers and content providers to create customized, comprehensive sets of messages. Users may specify their files and upload them directly to the Extranet 620 for provision to system 600, for example. For Push campaigns, advertisers may specify whether to create an e-mail package in HTML or text format or an SMS package in image or text format. For Pull campaigns, they may specify the audio initial message file and if response will be included whether they should be audio, e-mail (HTML or text) or SMS files (image or text). A creative approval wizard may allow administrators to approve new creative advertising packages created with the creative management wizard. Once the creatives have been approved, they can be managed through the creative management wizard as well, for example. Telemarketer Information: this feature allows advertisers and content providers to add a direct connect feature to their campaigns and to identify the phone number that will be called and the schedule that will be used for the direct connect feature.

Using an extranet 620 web page, advertisers and content providers can review and analyze the status of their contracts. Those with administrative privileges may also have access to tools that allow them to establish financial agreements and modify/update them as needed, including the ability to: add funds to contract; approve funds to be added; modify contract agent; edit contract terms; create new contract terms; terminate contract; and, change contract term dates.

Extranet 620 may be used to convert transactional call data on campaigns into detailed, relevant reports for analysis and planning. Included in the advertiser and content provider toolset may be: campaign comparison report to allow users to compare call and financial details of their campaigns. Also included may be campaign performance report to provide both summary and detailed information concerning campaign performance. This summary report may allow users to analyze the performance of specified campaigns based on one or more of the following characteristics: subscriber ad play frequency; ad play frequency by day of week; and ad play frequency by hour, for example. Also included may be a detailed report generator that creates dynamic, detailed reports that illustrate to users who their markets are by detailing the breakdown and distribution of message deliveries by demographic characteristic, location, or unique sub-scribers for a specified period. Also provided may be billing/invoicing to provide users with the means to track monthly ad charges (i.e., how much they have spent and what their money has been used for) and to review invoices (administrator privileges required) based on business data stored in the system. The Billing Reports feature may generate periodic, such as monthly, statements that indicate the amount billed to each campaign of a contract. Hyperlinks may provide detail on how much was billed per campaign for initial messages, response messages, and telemarketer direct connect minutes. Also provided may be a quick facts overview provided to users as a daily snapshot of the total number of ads displayed and the corresponding ad response rate, for example.

Utilizing extranet 620, operators may find the tools and reports they need to better understand and support the needs of their customer bases. Management tools may include: add/update subscriber profile; de-activate a subscriber profile; view subscriber account information; verify the existence of a MSISDN/MIN; Generate a new PIN; show lockout re-enable code; add a MSISDN/MIN to the database of valid subscribers; and, add a MSISDN/MIN range. Add/update subscriber profile: by entering a MSISDN/MIN (phone number), operators can help subscribers create their personal profiles or modify existing profile data. De-activate a subscriber profile: by entering a MSISDN/MIN, operators can de-activate accounts from the system. This disables a subscriber account and archives the subscriber's profile—preventing them from using the system. View subscriber account information: by entering a MSISDN/MIN, operators can re-view subscriber background and call history information that will help them sup-port their customer service needs. Verify the existence of a MSISDN/MIN: this feature allows and operator to verify whether a certain MSISDN/MIN exists in the database of valid subscribers. Customers need a valid MSISDN/MIN to register on the Media Platform. Generate a new PIN: this feature allows an operator to provide a subscriber with a new PIN needed to authenticate a subscriber so that they can access their profile. Show lockout re-enable code: this tool allows an operator to quickly reauthorize a subscriber who has been locked out of the system (after five PIN request failures) by providing them with the re-enable code needed to reactivate their PIN. Re-enable codes are changed daily. Add a MSISDN/MIN to the database of valid subscribers: this feature allows an operator to add a subscriber's MSISND/MIN to the database so that the subscriber is authorized to register with and use the Media Platform application. Add a MSISDN/MIN range: The feature allows an operator to add a range of MSISND/MINs that are able to register for the service. It also shows the ranges that are currently active.

Using extranet 620, raw transaction and profile data into detailed, relevant reports for operator analysis and planning. Included in an operator toolset may be a subscriber registration count report. Operators can use this tool to generate a sub-scriber registration count report, in text or graph format, for a specified period of time. This report indicates the number of new subscribers, by day, and how they registered on the Media Platform (i.e., via website, customer care, telephone). Included in an operator toolset may be a subscriber activity summary report. This tool generates a detailed summary of subscriber use of the service for the period of performance specified, allowing operators to review and analyze detailed call statistics to measure the success of their efforts. Included in an operator toolset may be a subscriber information report. The operator uses this tool to acquire basic user information, including call plan, subscriber language(s) and free call minutes remaining (if an advertising subsidized service). Included in an operator toolset may be an active subscriber report. This reporting tool generates summary statistics on the number of unique active subscribers for the period of performance the operator chooses. Operators can use these statistics to monitor active subscriber pat-terns over time. Included in an operator toolset may be a subscriber growth report. This reporting tool provides the total number of calls placed by new and existing subscribers over the period specified and allows operators to track the growth of their subscriber base and call load. Included in an operator toolset may be a subscriber demographics report. This tool breaks down information subscribers provided in their questionnaires to provide detailed demographic statistics on their subscriber base, in text or graph format. Included in an operator toolset may be a campaign revenue billing report. This tool provides detailed financial information for each campaign for the month specified by the operator, including total charges for each campaign, by rate set, so that operators can determine the revenue generated by system each month. Included in an operator toolset may be a quick facts overview provided to operators is a daily snapshot of the total number of subscribers, number of new subscribers, and number of sponsored minutes, for example.

Subscribers may interact with the system through a subscriber web site, which may be provided using the extranet 620 for example. Such a site can provide information on using the service as well as functions that allow subscribers to update their profiles, check on usage, and view messages that the system has delivered to them. To facilitate subscriber access to profile and service management functions, the system 600 may generate a random PIN that is sent to the subscriber via SMS. This provides a secure mechanism for subscribers to access a web site and other support channels. This interface can be customized per client specification. The system 600 may support other application-specific interfaces. One example is a content provider that delivers updated audio and text messages daily. The Media Platform can be configured to accept media files and targeting definitions (supplied in XML) from an FTP server hosted on the platform, automatically upload the media files to databases or file systems as necessary, and create and enable the new campaigns.

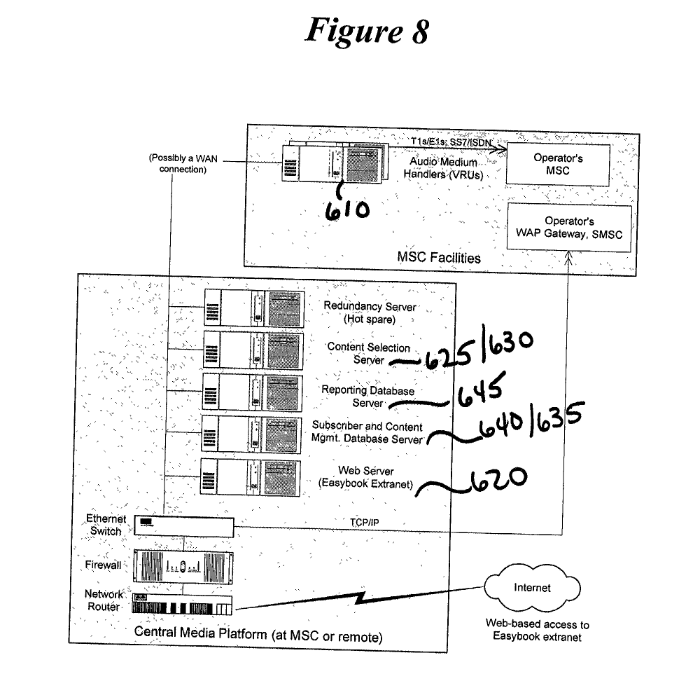

Referring now also to FIG. 8, there is shown an architecture suitable for use as the system 600 of FIG. 6 according to an aspect of the present invention. According to an aspect of the present invention, a Content Selector Server is responsible for the “front-line” communication with the medium handlers 610. Running on this server may be the Content Selector 625 and the Content Selector Database 630. The Content Selector 625 communicates with the medium handlers in real-time using a private TCP/IP connection (i.e., leased line, frame relay, VPN, ISDN) for example. Redundancy for the system 600 may be based on an n+1 model, in which there exists one fully configured server in excess of the number required. Software agents running on the primary server may provide real-time updates to the redundant server and, in the case of a primary server failure, the redundant server can be configured to act in place of the failed component. Although parts of the failover can be configured to occur automatically, the system typically employs manual intervention.

A suitable configuration for the Content Selector Server may include: 2×Pentium III 733 mhz processors, 128 mb RAM, Compaq 5304 raid controller, 4×18.2gb SCSI-3 15 k hard drives in an internal bay, 2×9.1gb SCSI-3 15 k hard drives in internal cage, suitable operating system such as Microsoft Windows 2000 Server, and suitable database such as Microsoft SQL Server 2000.

A Subscriber and Content Management Database Server contain the databases that support subscriber profiles and campaign management data, e.g., 635, 645. It provides a non-real-time staging area for data entered through the extranet 620 and other sources These data are then replicated to the Content Selector Database Server to provide fast access for the Content Selector 625. A suitable configuration may take the form of 4×Pentium III 700 mhz Xeon processors, 1 gb RAM, Compaq 5304 raid controller, 4×9.1 gb SCSI-3 10 k hard drives in an internal bay, 4×18.2 gb SCSI-3 15 k hard drives in external cage bay, suitable operating system such as Microsoft Windows 2000 Server, and suitable database such as Microsoft SQL Server 2000.

Reporting Database is an operational data store for billing and reporting information, e.g. database 645. It may be accessed by users through a Web Server and allows authorized users to retrieve report information. It may be responsible for executing both on-demand report queries and periodically running complex, time consuming reports automatically during off-peak hours. Disk sizing for this system is de-pendent on the amount of historical data the operator wishes to store before it is archived. Three months is a typical storage requirement.

If a high availability solution is required for extranet 620, this server can be implemented as a cluster of servers, with the database configured to replicate to a standby machine. Clustering is a higher cost implementation because of the additional hardware and soft-ware costs. However, the standby server can monitor the health of the active server; and when there is a problem, assume control of the database. Restoration times may range from 5 to 25 minutes, depending on the size of the database.

The Reporting Database server may share information with the Content Selector Database Server and the Subscriber and Content Management Database Servers, by periodically synchronizing data between them. The operating system, database transaction logs, database back-ups (full and transaction log), and SQL Server management databases may run on a RAID-1 data set. The database data files run on a RAID-5 data set. A typical system configuration for the Reporting Database server may include: 4×Pentium III 700 mhz Xeon processors, 2 gb RAM, 4×9.1 gb SCSI-3 10 k hard drives in an internal bay, 14×18.2 gb SCSI-3 15 k hard drives in external cage, suitable operating system such as Microsoft Windows 2000 Server, and suitable database such as Microsoft SQL Server 2000.

As discussed previously, the extranet 620 provides the operator and its advertisers and content partners with tools for managing campaigns. These tools may be available using standard Web interfaces. The Reporting Database and Web Server in the schematic above support the functions of the targeting module, campaign management module, reporting module, and billing module.

The Web Server may be responsible for the extranet 620 user interface to system, 600. Access to the Web Server may be protected with 40-bit Secure Sockets Layer (SSL) encryption. The operator may assign authorized users of extranet 620 with user-names and passwords and prescribes the level of access to features and accounts each user is allowed (i.e., advertisers cannot view competitors' campaigns).

The Web Server may support any suitable number, such as up to 1,000, concurrent users. If desired, additional servers can be specified for added capacity and availability. The Web Server can allow users access to their profiles through the use of a subscriber-oriented web site. The server can also be enabled to provide promotional information about the service, allow subscribers to register with the service and complete profile questionnaires, and allow existing subscribers to view and/or modify their registered pro-files. A typical system configuration for the Web Server may include: 2×Pentium III 733 mhz processors, 512 mb RAM, Compaq 5304 raid controller, 4×18.2 gb SCSI-3 15 k hard drives in internal bay, 2×9.1 gb SCSI-3 15 k hard drives in internal cage, suitable operating system such as Microsoft Windows 2000 with Microsoft IIS and Cold Fusion Server.

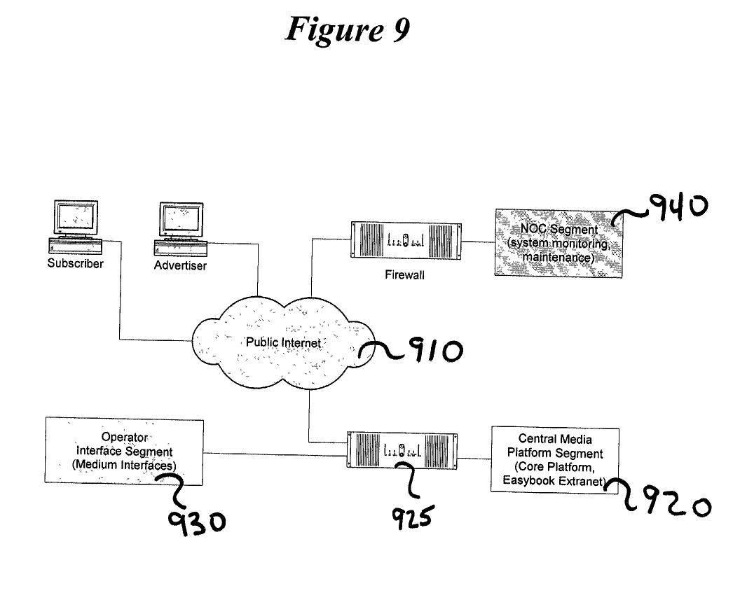

Referring now also to FIG. 9, there is shown a block diagrammatic representation of a network segmentation according to an aspect of the present invention. Security within the system 600 may begin with subdividing the network into four segments. This “logical segmentation” allows traffic flowing between the functional areas of the system to be monitored and controlled.

The first segment of the logical network architecture is the public Internet 910. Traffic on the Internet is inherently insecure; consequently, data of a non-public nature transiting this segment must be encrypted to protect it from unauthorized access and modification. Additionally, interfaces between the Internet and other segments of the system must limit traffic not originating from trusted hosts.

A central media platform segment 920 of the logical network architecture includes system 600 and the extranet 620. This segment may be physically protected so that non-public information may be transmitted between elements within the system 600 unencrypted.

The network affiliate interface segment 930 of the logical network architecture contains interconnections with the operator's mobile network (i.e., MSC, SMSC, and WAP gate-way). The Audio Handler (VRU) may be a part of this logical segment. As with the central Media platform segment 920, this network segment may be physically protected.

The Network Operation Center (NOC) 940 may include those systems that interact with systems associated with a particular network affiliate's implementation. As with all non-public network components, physical protection of these systems is required.

The physical realization of this four-part network architecture may be accomplished with the assistance of Internet firewall technology. A firewall is a system component that examines traffic transiting a particular point on a network, deciding whether or not to allow a particular bit of network traffic to pass depending on the characteristics of the traffic itself. Filter settings determine the type of traffic that is allowed to pass through the firewall from one network interface to another. Good security dictates the use of a policy that forbids any access not explicitly permitted by policy. Filter settings are typically as follows: Permit HTTP and HTTPS connections from any external source to the Web Server (This allows external users to access the Web Server for the purpose of user profile and system management.); Permit communications between the content selection server and the audio handler on the TCP/IP port(s) associated with the request/response protocol; Permit read-only SNMP service from the NOC to the servers on the Central Media Platform Segment (This allows the operator to ascertain the state of the Media Platform.); Permit Common Internet Filesystem/Server Message Block (CIFS/SMB) connections between the Web Server and the audio handler in order to update ads and content as required; Permit virtual private network (VPN) connections between the NOC Segment and the Central Media Platform Segment; Permit virtual private network (VPN) connections between the NOC Segment and the audio handler, if appropriate; deny and log everything else.

WatchGuard Technologies' Firebox II network firewall appliance may be used. Alternatively, Check Point Software's Firewall-1 software version 4.1 running on a Sun Solaris 2.7 server may be used. The WatchGuard firewall supports a wide range of VPN encryption protocols, including IPSec (128-bit MD5-HMAC, 160-bit SHA1-HMAC, 56-bit DES-CBC, and 168-bit 3DES-CBC) and a proprietary IP tunneling solution that employs 40- and 128-bit RSA RC4. Both WatchGuard and Checkpoint firewall products provide in excess of 99.9% availability. The Firebox II provides a total of three separate Ethernet interfaces. This allows direct mapping between the logical network architecture outlined previously and a physical implementation. In the parlance of the FireBox hardware, these interfaces are referred to as the external, trusted, and optional interfaces. The external interface is intended for connection to an untrusted network such as the Internet. The only difference between the “trusted” and “optional” networks is associated with the default policy for firewall management, which expects firewall management commands to originate on the trusted network. The mapping between logical and physical interfaces is as follows:

Internet segmentation can be connected to the “external” interface of the FireBox II. The central media platform segment may be connected to the “trusted” interface of the Fire-Box II. The operator interface segment may be connected to the “optional” interface of the FireBox II. The NOC Segment may be connected to the “trusted” interface of a second Firebox II located at the NOC itself.

The NOC may require access to the central media platform segment and the operator interface segment in order to maintain and manage the Media Platform. These connections may be inherently sensitive; moreover, because the exact nature of the connections required for maintenance/troubleshooting purposes can be difficult to characterize, the system may employ Virtual Private Network technology. Characteristics of the VPN include user authentication in which each user of VPN services is individually authenticated and anonymous access is not permitted. VPN traffic may be encrypted.

The operator may securely monitor firewall configuration remotely from the NOC. Policy changes may be protected using a pass phrase combined with highly secure, 168-bit 3DES-CBC encryption, for example. Further, an operator may be able to independently assure the safety and security of its own network. The system 600 may provide the operator with access to the firewall associated with the operator interface segment (the firewall 925 in FIG. 9). This access permits the operator to independently verify the installed security policy, as well as view the state of all connections traversing the firewall without requiring prior coordination. This access only applies to the firewall associated with the operator's network; no access is provided to the firewall protecting the NOC unless the operator runs the NOC.

The Wireless System Operator, and not the Content Service Provider holds the encryption key. So long as the Content Service Provider does not release the User Profile database to the Wireless Service Provider, and the Wireless Service Provider does not release the encryption key to the Content Service Provider, neither party possesses enough information to associate subscriber identity with User Profile database information, thus ensuring user privacy.

The Targeting ID is then preferably passed to the content selector. Identification and processing within the User Profile database is accomplished using this ID. Coordination with the Privacy Server is accomplished by use of the Targeting ID. The content selector completes the transaction by informing the media handler of the selected content, which it delivers to the user.

Preferably the wireless service operator periodically changes the key to the encryption function used by the Privacy Server (e.g., when the employment of personnel having access to the key terminates). Since the targeting ID is derived from data encrypted with this key, an added step is required to convert the old targeting ID for each subscriber to one based on the new encryption key.

In addition to firewall protection, the system 600 may employ a number of other mechanisms designed to ensure the security and integrity of its systems as well as those of the operators it serves. A content management model may be designed to provide the operator with ultimate control over the advertisements and content received by the operator's subscribers. Advertisers and content providers may not be allowed to update campaigns immediately. Instead, when an update is received, it may be presented to the operator via the extranet 620 for review and approval. Only after approval has been received may the content be made available to subscribers via the audio handler. The security profile of each individual server may also play a large role in ensuring the over-all security of the system 600. If Windows 2000 is the operating system installed on the servers that make up the system, a suite of best practices to secure these servers, such as the techniques outlined in the U.S. National Security Agency's Report C4-008R-99 (“Guide to Securing Microsoft Windows NT Networks”) may be employed. The host hardening procedure will be documented as part of the integration process.

If the Media Platform is not installed and run by the operator, the operator may be uncomfortable empowering the outside party with access control between an their network and the public Internet. Consequently, the operator may deploy its own redundant firewalls, configured to enforce the security policy as described.

The content may be aggregated from various media, including, without limitation, Newspapers, TV, Radio, Internet, Merchants, Service Providers and Media System Users. Such content is sourced and classified into categories and rated based on relevance criteria and constraints, that are defined for each content category. For example, a music story is classified under “Music” and rated to have high relevance association factor with jazz, country, or pop, depending on the editorial focus of the story or headline. Constraints may include the length of an associated audio message, screen size, or page. Advertising content is classified into one or more advertising categories such as, discount coupon, promotion, or type of goods advertised, and rated based on relevance criteria defined for each category and constraint.

For example, a discount coupon from HomeDepot, can be rated to have high relevance association factor with hardware, gardening or construction materials. Constraints related to such a coupon are limited to a relative small number of characters, if the chosen medium is Short Messaging Service (e.g. 100-160 characters). Content is then produced for delivery in one or more appropriate forms as applicable to the selected delivery device and medium, such as audio, short message summaries, Web, or WAP information pages or links to such pages, images, or video. The User Profile may dictate content selection depending on applicable medium, interests, and required content characteristics, defined in terms of constraints and relevance factors.

The produced and rated content forms the Media inventory. Associated campaigns may then be created manually through the Media Campaign Management System by selecting the applicable distribution rules based on content characteristics, specified in terms of relevance factors, constraints, and users profiles.

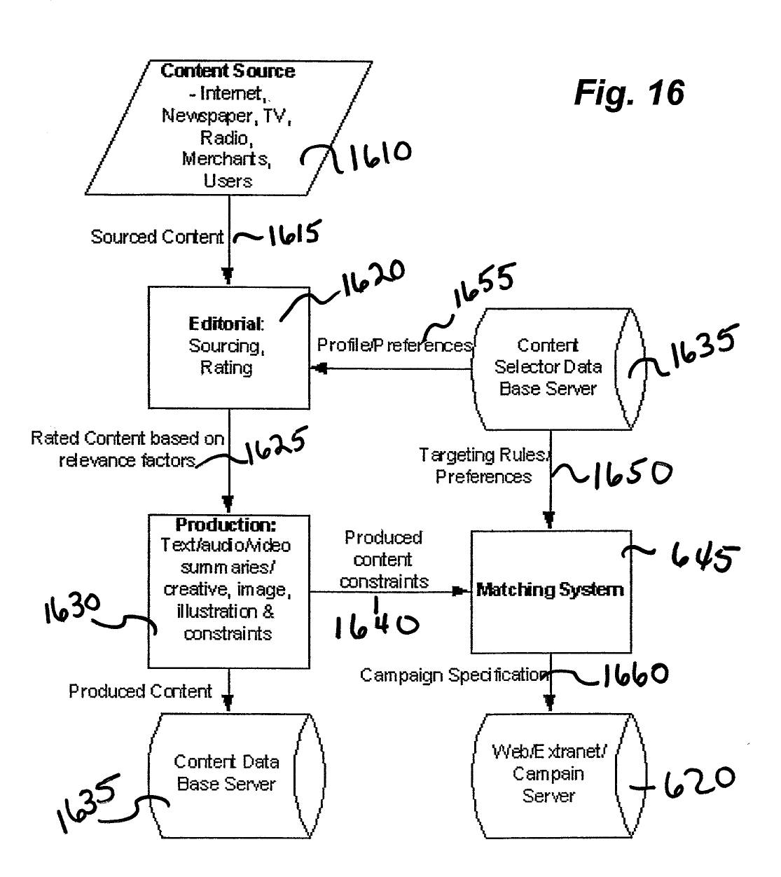

Alternatively, campaigns can be created automatically to define the content distribution rules based on desired user targeting information and the degree of relevance/constraints associated with each piece of content. Such campaigns are then hosted, managed, and executed by the M'P System. The process associated with content aggregation, provisioning and campaign creation is depicted in FIG. 16.

Customer profiling is preferably performed by way of a questionnaire requiring explicit multiple-choice answers, indicating personal information or preferences that are derived from Media System targeting objectives. The answers to such questions, together with content constraints and relevance factors, form the Campaign Targeting Rules. A questionnaire may be provided online or via live operator prior to service activation.

A preferred form of Personal Profile Questionnaire comprises two segments: the Standard questionnaire and the Local Questionnaire. The Standard Questionnaire comprises questions such as: age group; gender; income (in local currency); and other universal concepts, including lifestyle and interests. This questionnaire should contain sufficient information to target products with wide appeal (e.g., a sports shoe company) to large groups with ease.

The Local Questionnaire comprises questions relevant to the particular area where the subscriber receives the sponsored service. Tailoring the questionnaire to a particular geographic area allows localized targeting in specific markets.

The Standard Questionnaire comprises questions such as: age group; gender; income (in local currency); and other universal concepts, including lifestyle and interests. This questionnaire should contain sufficient information to target products with wide appeal (e.g., a sports shoe company) to large groups with ease.

The Local Questionnaire comprises questions relevant to the particular area where the subscriber receives the sponsored service. Tailoring the questionnaire to a particular geographic area allows localized targeting in specific markets.

Completed questionnaires are then uploaded to the media Platform, creating a database of E-Personalities. These E-Personalities mature according to the attributes utilized as the NVP System records subscriber responses. Furthermore, the profiles can be enriched with additional attributes which operator client may have collected and developed through other interactions with their users and external data mining activities. Most importantly, as a significant database of profiles is developed, learning from the actions of one profile can be used to infer information regarding consumers who may have provided less information than the majority of users. This same information is also used for collaborative filtering techniques to generate the most appropriate choices of advertising and content delivery.

The design of the questionnaire must take a number of issues into account: Targeting information needs; Methods of registration; Ease of registration; Privacy sensitiveness; Technical database formats; and Reporting capabilities.

Alternatively, preference related information may be collected after user service activation, using the content delivery service itself. This can be achieved by means of specialized campaigns designed for the explicit fulfillment of users preferences. Answers are then collected as they become available to incrementally enhance the Users Profiles.

Additionally, in a preferred embodiment of the present invention, data mining, predictive analysis, and collaborative filtering based on users' responses and interaction with the system allow for continuous refinement of users' behavioral profile to targeting on such characteristics, depending on campaign criteria. For example, consistent data mining of use of the system over a period of time, of users' responses to certain type of messages or activations of certain service features, may indicate new preferences or changes in existing preferences. A consistent call pattern to certain merchants or content providers may indicate certain needs and may enrich the campaigns targeting rules.

Often regulatory requirements mandate that users provide consent to use their personal information (opt-in service). Such consent may be obtained through an initial campaign defined for that purpose and targeting newly activated users.

Campaigns may be designed to deactivate a user for failure to respond to such campaigns. In a preferred embodiment, the present invention may be used for various applications, including without limitations: Informational and entertainment content delivery; Local and location based content delivery; Advertising and promotional content delivery; Classified advertisement; Affinity groups content distribution and alerts; Commerce transactions—triggering and fulfillment; Games; examples: trivia, treasure hunt, etc.; Instant market research and polls; Voting and elections; Contests and lottery; Loyalty programs; Credit users may earn points for responding to select advertising messages delivered to them that may be used to redeem certain services including Operator services and participating merchants service subsidy; and Users may accumulate credits by responding to selected advertising messages delivered to them.

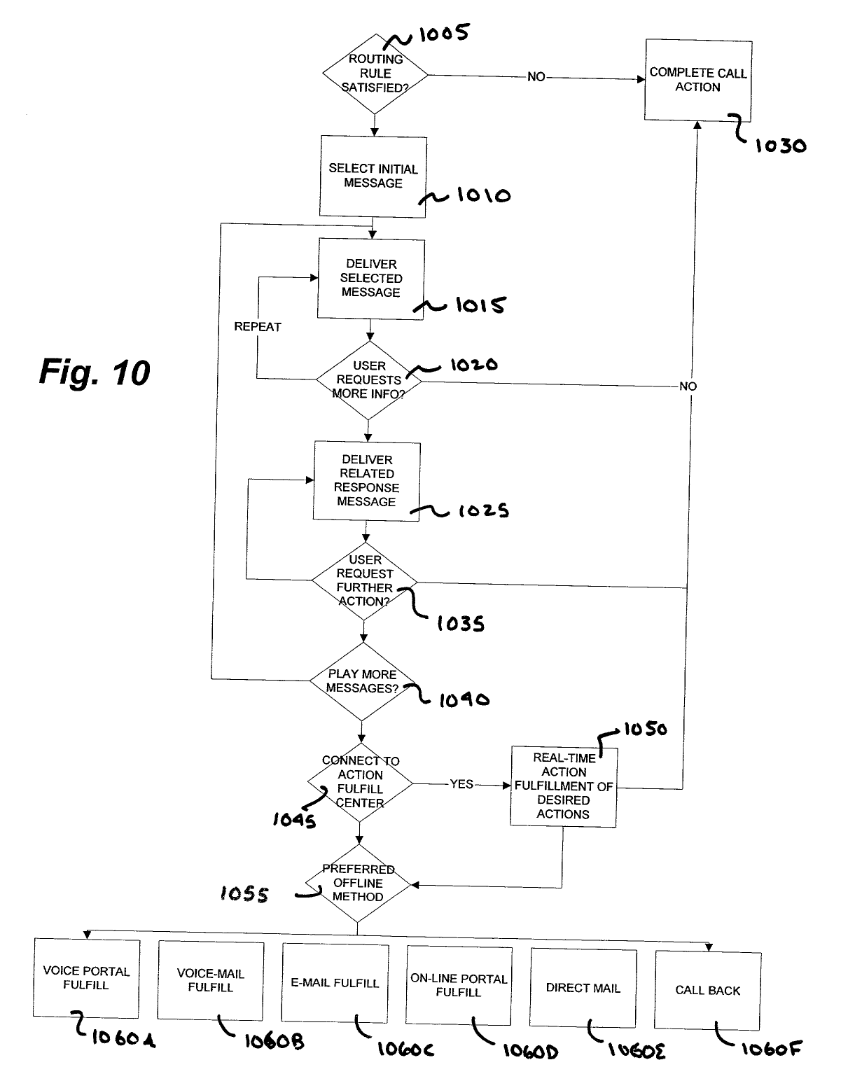

Referring now to FIG. 10, there is shown a method for initial messaging and response during a call or action session. First, a call action is determined to satisfies immediate routing rules 1005. If the rules are satisfied, then an initial message is selected 1010. This selected message is then delivered 1015. If the user requests more information 1020, a related response message may be delivered 1025. If the user presses a repeat key, the selected message may be delivered again 1015. Otherwise the call or action may be completed 1030. Once the related message has been delivered 1025, a user may request further action 1035, or press a repeat key, which again, causes the related message to be delivered 1025. If the user does not request further action 1035, the call or action may be completed 1030. If the user does request further action 1035, it may be decided whether or not to play more messages 1040. If more messages are selected to be played 1040, the selected messages may be delivered 1015. If no more messages are determined to be played 1040, a connection to a fulfillment may be made 1045. If the connection 1045 is made, real-time action fulfillment of desired actions may be achieved 1050. If no connection to a fulfillment center can be made 1045, or after fulfillment 1050, the user preferred offline fulfillment method may be determined 1055. Fulfillment, via the selected preferred method, may then be achieved 1060A-1060F.

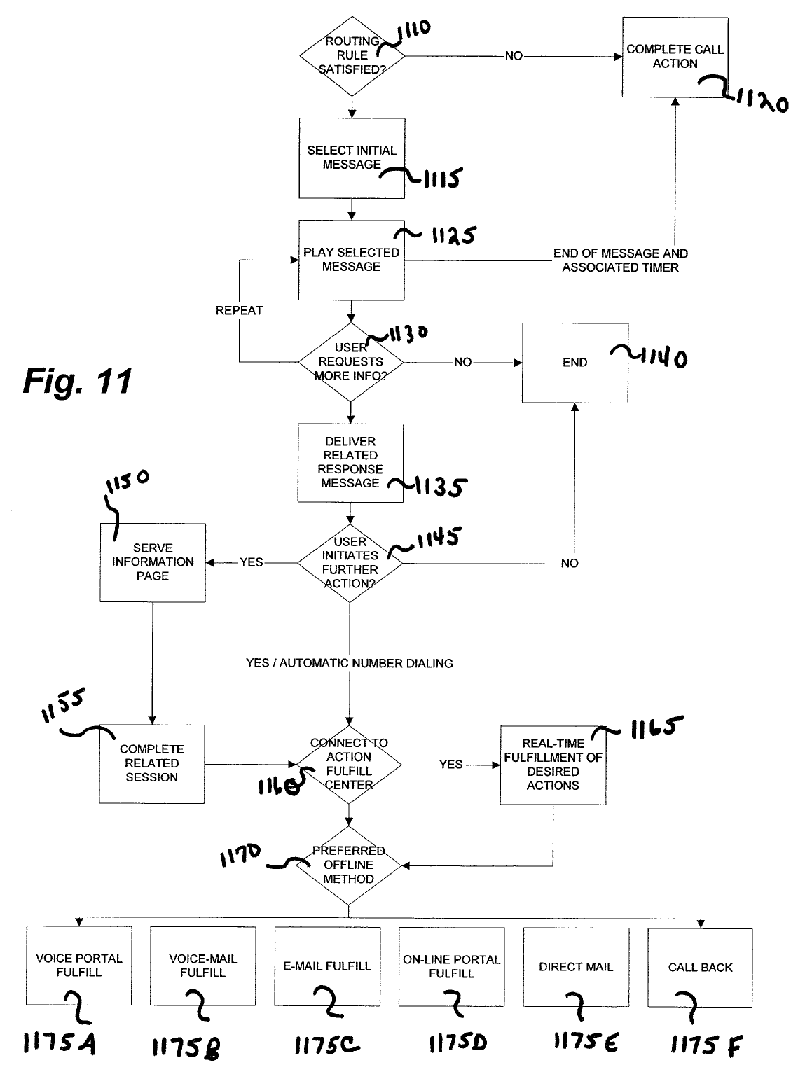

Referring now to FIG. 11, there is shown a method for initial message response and a post action initiation session according to an aspect of the present invention. If a call or action satisfies media routing rules 1110, an initial message may be selected as being applicable 1115. If an applicable message has been selected 1115, it may be played 1125. If an associated timer, if any, has ended, the call action may be completed 1120. If not, a call may be completed 1120. Thereafter, a user may request more information 1130. When the user presses a play or repeat key, the selected message may again be played 1125. If the user does request more information 1130, related messages may be delivered 1135, otherwise the method may end 1140. Once related messages have been delivered 1135, a user may initiate further action 1145. If no further actions are initiated 1145, the process may end 1140. If the user does initiate further actions 1145, an applicable information page message or link may be served 1150. When served, the related session may be completed. If a connection to a fulfillment center is determined to be appropriate 1160, a real-time fulfillment of the desired action may be achieved 1165. Otherwise, a user preferred offline fulfillment method may be determined 1170 (in addition to after real-time fulfillment 1165 as well) and the determined preferred offline fulfillment method may be achieved 1175A-F.

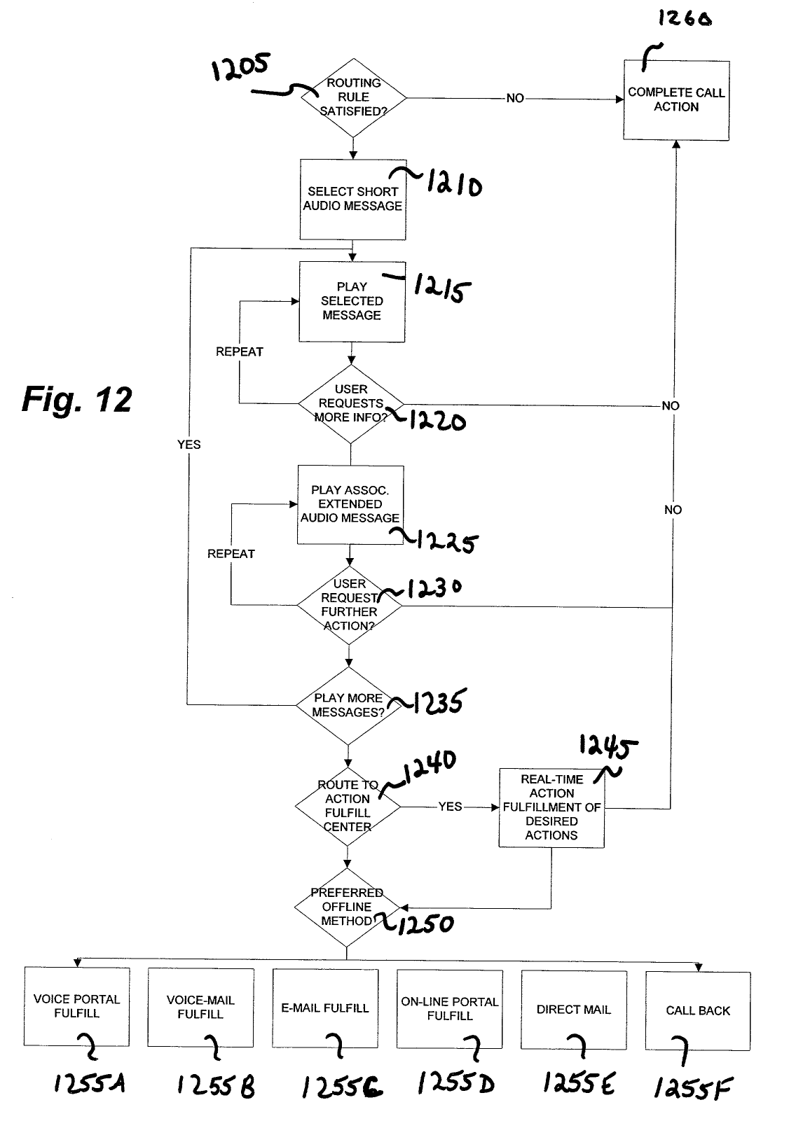

Referring now to FIG. 12, there is shown a method according to an aspect of the present invention for audio-based response fulfillment. It may first determined whether or not a caller action satisfies an media routing rules 1205. If not, a call or action may be completed 1260. If the call does satisfy one or more of the media routing rules 1205, an applicable short audio message may be selected 1210. The selected message may be then be played 1215. It may then be determined whether or not a user requests more information 1220. If the user presses a repeat key, the selected audio message may be played again 1215. If the user does request more information, one or more extended audio messages may be played 1225. If not, the call may be completed 1260. If the user requests further action 1230, it may be determined whether or not to play more messages 1235. If so, messages may be played 1215. If no further actions requested, the call may be completed 1260. If no further messages are to be 1235, it may be determined whether or not the call should be routed to a fulfillment center 1240. If the call should be routed to a fulfillment center 1240, real-time action fulfillment may be achieved 1245, and the call may be completed 1260. If real-time action fulfillment has not been achieved 1245, a user preferred offline fulfillment method may be selected 1250. Further, if the call should not be routed to a fulfillment center, the user preferred offline fulfillment method may be selected 1250. Thereafter a selected preferred offline fulfillment method may be completed 1255A-1255F.

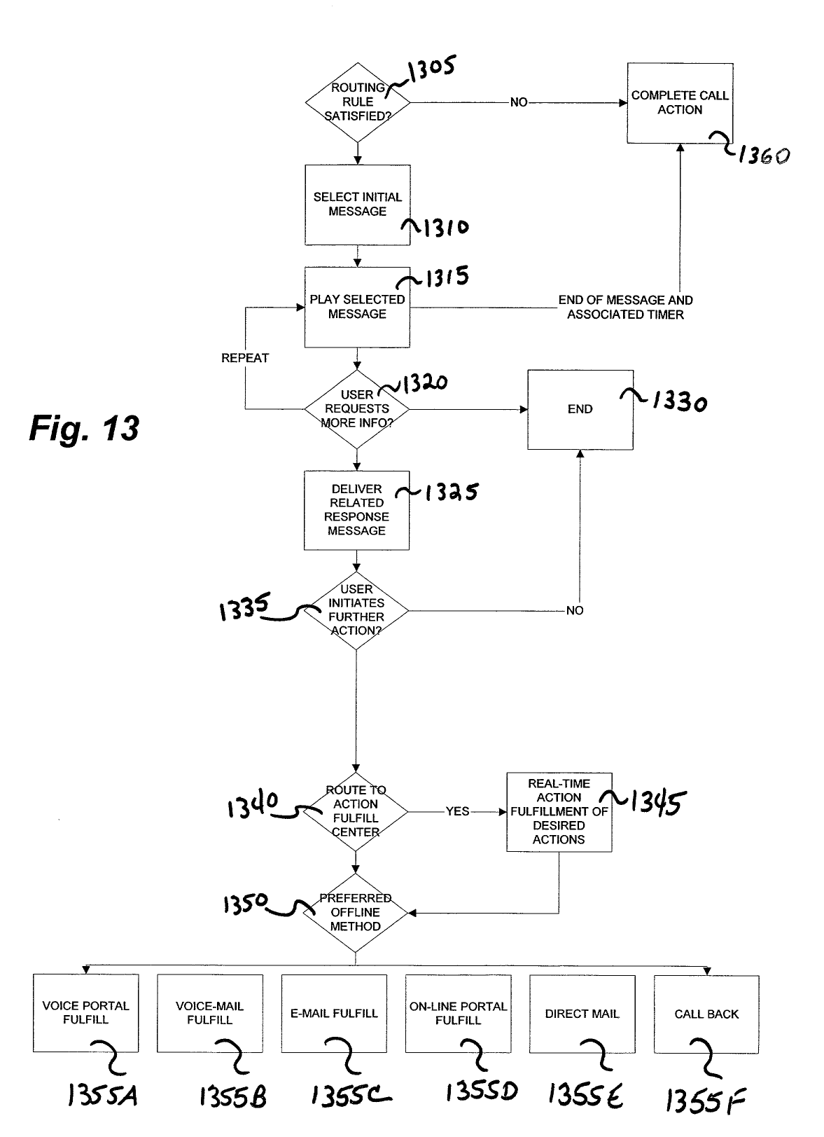

Referring now to FIG. 13, there is shown a method for text message based response fulfillment according to an aspect of the present invention. Again, it may first be determined whether or not a call satisfies a media routing rule 1305. If not, the call may be completed 1360. If the call does satisfy the media routing rules 1305, an applicable short message may be selected 1310. The selected message may be played 1315. If it is the end of the audio and the associated timer has expired, the call may be completed 1360. Otherwise, it may be determined whether or not the user selects to request more information 1320. If the user presses a repeat key, the selected audio message may be played again 1315. If the user does request more information, a related message may be delivered 1325. Otherwise, the process may end 1330. If a related message has been delivered 1325, it may be determined whether the user has initiated further action 1335. If not, the process may end 1330. If so, the call may be routed to a fulfillment center 1340. If it is determined to be routed 1340, real-time fulfillment of desired actions may be achieved 1345. If not, the user preferred offline fulfillment method may be determined 1350. Thereafter, the preferred offline fulfillment method may be used 1355A-1355F.

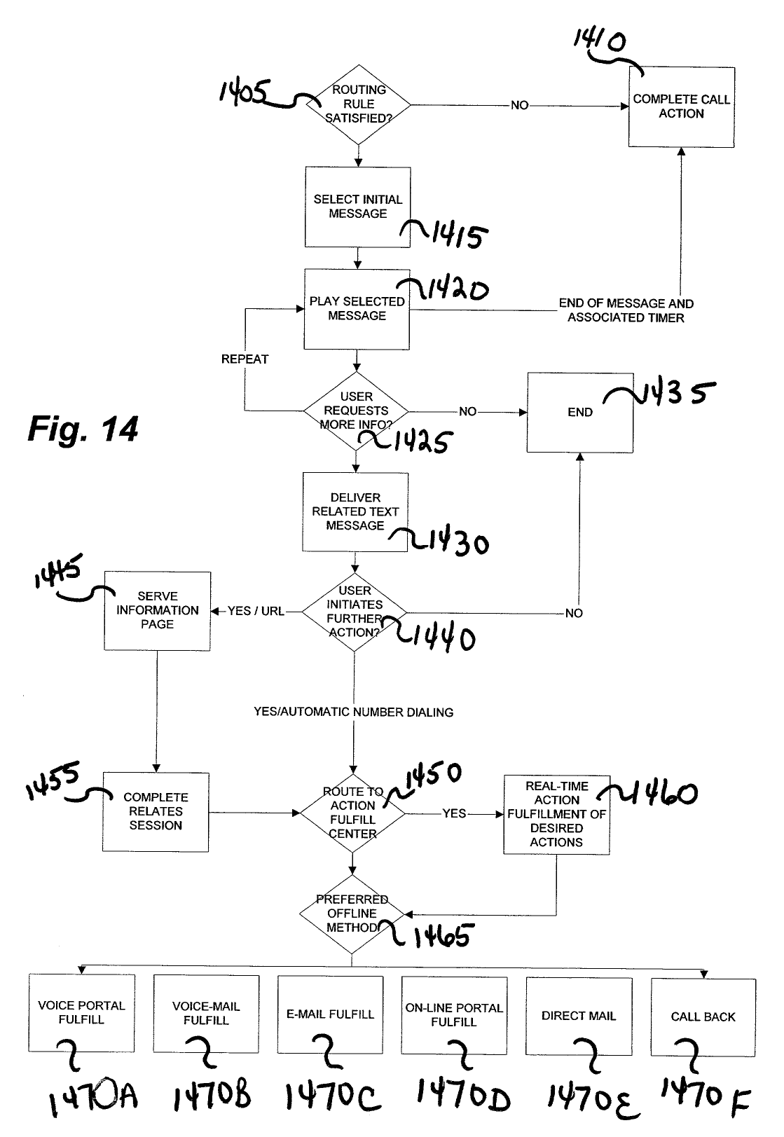

Referring now to FIG. 14, there is shown a browser based response fulfillment method according to an aspect of the present invention. First it may be determined whether or not a call satisfies media routing rules 1405. If a call does satisfy media routing rules 1405, a short audio message may be selected 1415. Otherwise, the call may be completed 1410. The selected message may then be played 1420. If at the end of the audio message an associated timer has expired, the call may be completed 1410. Otherwise, it may be determined whether or not the user requests more information 1425. If the user presses a repeat key, the selected audio message may again be played 1420. If the user has requested more information 1425, the related text message with an embedded URL or contact number, for example, may be delivered 1430. Otherwise the process may end 1435. It may then be determined whether or not the user has initiated further action 1440. If not, the process may again terminate 1435. If the user has initiated further action 1440, applicable information may be served as part of an information page 1445. If automatic dialing is instead desired, as opposed to a URL link being embedded in step 1430, the user may be routed to a fulfillment center 1450. Once an applicable information page has been served 1445, a related browsing session may be completed 1455. Thereafter, real-time fulfillment of desired actions may be achieved pursuant to routing 1450 (step 1460). If the call cannot be routed 1450, or real-time fulfillment could not be achieved for example, a preferred offline fulfillment method may be determined 1465. Thereafter the preferred offline fulfillment method may be utilized 1470A-1470F.

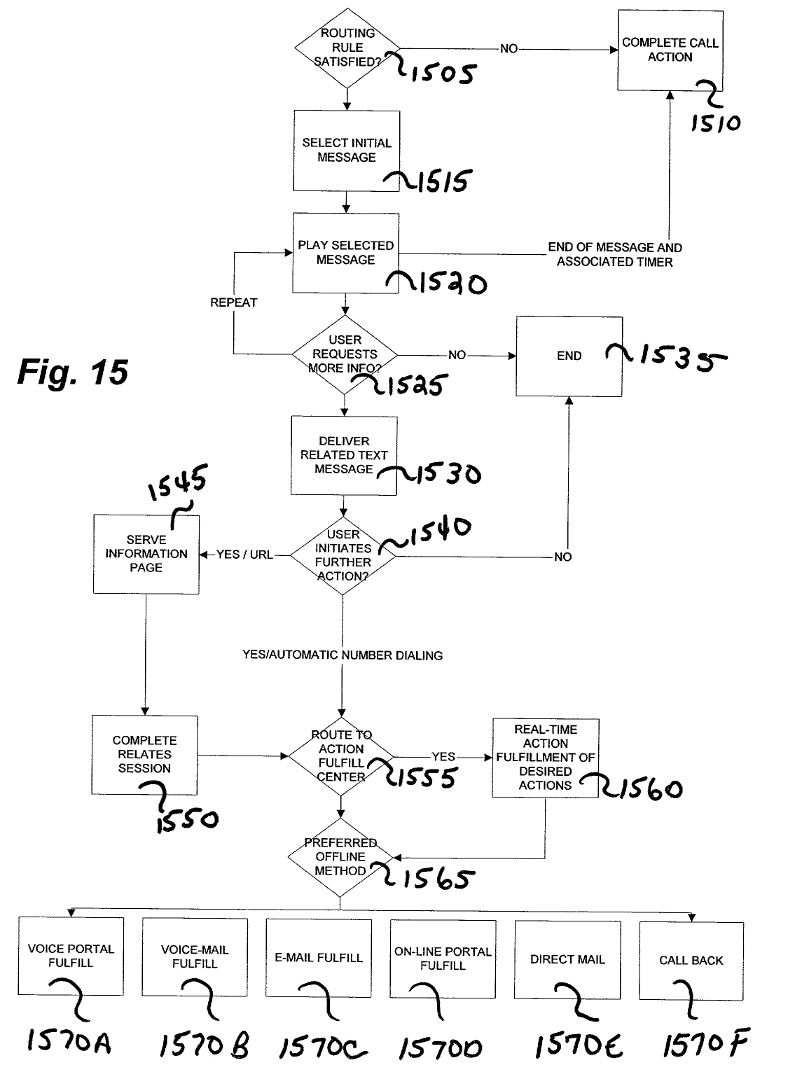

Referring now to FIG. 15, there is shown a method for image video based response fulfillment according to an aspect of the present invention. Again, it may be determined whether or not a call or action satisfies a media routing rules 1505. If not, the call may be completed 1510. If so, an applicable short audio image or video message may be selected 1515 and played 1520. Thereafter, if it is the end of the message and an associated timer has expired, the call may be completed 1510. Otherwise, it may be determined whether or not the user requests more information 1525. If so, a related message may be delivered 1530. Otherwise, the process may end 1535. If delivery accomplished 1530, it may be determined whether or not the user has initiated further action 1540. If not, the process may end 1535. If so, an information page with still image or video clip, for example, may be served 1545 and optionally including one or more Uniform Resource Locators (URLs). Thereafter, a related browsing session may be completed 1550. Thereafter, or if an automatic number dialing has been provided as part of the delivered message 1530, a call may be routed to the fulfillment center 1555. If the call is routed, real-time fulfillment of desired actions may be achieved 1560. If not, an offline preferred fulfillment method may be selected or determined 1565 and thereafter used 1570A-1570F.

Referring now to FIG. 16, there is shown a block diagrammatic illustration representative of a method and system for content aggregation and a provisioning according to an aspect of the present invention. Content sources 1610 may be used to provide sourced content 1615. Thereafter, editorial services 1620 may be provided. Rated content based on relevance factors may then be delivered to production 1625. Production may include text, audio or video summaries as well as creation of images, illustrations or constraints 1630. Thereafter produced content may be provided to one or more servers 1635. The produced content from production 1630 may be delivered 1640 for matching 1645 by a matching system. Matching 1645 may further use rules which have been delivered 1650 from content selector server. The content selector server may also provide profile and preferences information 1655 for the editorial services provided 1620. The match system may perform the matching 1645 to communicate campaign select specification information 1660 to extranet servers.

It will be apparent to persons of ordinary skill that various modifications and variations may be made to any of the elements of the service, system, and method of the present invention, without departing from the scope of the invention as claimed. Thus, it is intended that the variations and modifications of the invention be included, provided they come within the scope of the appended claims and their equivalents.

What is claimed is:

1. A method for providing informational content to a user of a communications device being wirelessly communicatively coupled to a communications network, said method comprising:
identifying information associated with said user and indicative of user attributes;
selecting a plurality of candidate messages using said identified information;
pseudo-randomly selecting at least one of said plurality of candidate messages as selected content; and,
delivering said selected content to said communications device using said wireless communications network.

2. The method of claim 1, wherein said identifying is responsive to a request for services.

3. The method of claim 2, wherein said services are wireless communications services.

4. The method of claim 3, wherein said identifying, selecting, pseudo-random selecting, delivering are performed in real-time.

5. The method of claim 3, wherein said delivered content includes some advertising information.

6. The method of claim 5, wherein a majority of said delivered information is advertising information.

7. The method of claim 5, wherein a majority of said delivered information is non-advertising information.

8. The method of claim 1, further comprising receiving a request for further information in response to said delivered content.

9. The method of claim 8, further comprising delivering information indicative of said delivered content in response to receiving said request for further information.

10. The method of claim 1, wherein said delivering comprises transmitting at least one audio message.

11. The method of claim 1, wherein said delivering comprises transmitting at least one text message.

12. The method of claim 11, wherein said at least one text message is an SMS message.

13. The method of claim 1, wherein said content comprises at least one uniform resource locator.

14. The method of claim 1, wherein said delivered content comprises information indicative of a telephone number.

15. The method of claim 14, wherein said information indicative of a telephone number comprises information for automatically dialing said telephone number using said communications device.

16. A method for providing aggregated content to a user of a wireless communications network, the wireless communications network capable of supporting data transmission, and comprising at least one base station, at least one base station controller, and at least one wireless access device, said method comprising:
receiving content from at least one content source;
classifying the content into a plurality categories;
rating the content based on relevance factors and constraints defined for each of the plurality of categories;
matching the classified and rated content with user criteria;
selecting content to be provided to the user based on the results of said matching; and
providing the matched content to the user.

17. The method according to claim 16, wherein the at least one content source is selected from the group consisting of: Newspapers, TV, Radio, Internet, Merchants, Service Providers, and other users.

18. The method according to claim 16, wherein the constraints are selected from the group consisting of length of text message, length of audio message, length of video clip, and screen size.

19. The method according to claim 16, wherein the user criteria is selected from the group consisting of location, profile, questionnaire, responses, keypad interactions, voice activated responses, stylus responses, personal profile enhancement questions, polls, games, e-commerce/m-commerce transactions, interactive applications with broadcast or other media, and SMS messages.

20. A computer program product embodied on a computer-readable storage medium for providing informational content to a user of a communications device being wirelessly communicatively coupled to a communications network, the computer program product comprising:
code for identifying information associated with said user and indicative of user attributes;
code for selecting a plurality of candidate messages using said identified information;
code for pseudo-randomly selecting at least one of said plurality of candidate messages as selected content; and,
code for delivering said selected content to said communications device using said wireless communications network.
